(19) United States
(12) Patent Application Publication
(10) Pub. No.: US 2012/0274532 A1
(43) Pub. Date: Nov. 1, 2012

(54) ANTENNA DEVICE AND ELECTRONIC DEVICE

(75) Inventors: Shigemi Kurashima, Tokyo (JP); Masahiro Yanagi, Tokyo (JP); Hideaki Yoda, Tokyo (JP)

(73) Assignee: FUJITSU COMPONENT LIMITED

(21) Appl. No.: 13/429,683

(22) Filed: Mar. 26, 2012

(30) Foreign Application Priority Data
Apr. 27, 2011 (JP) 2011-099919

(51) Int. Cl. H01Q 1/48; H01Q 19/02

(52) U.S. Cl. 343/833; 343/848

(57) ABSTRACT

A disclosed antenna device includes a ground part, a first stub connected to the ground part, a first inverted-F antenna element including a first power feeder, a second stub connected to the ground part, and a second inverted-F antenna element including a second power feeder, wherein the ground part has a linear part between a first connecting part between the first stub part and the ground part and a second connecting part between the second stub part and the ground part.

### CROSS-REFERENCE TO RELATED APPLICATIONS

This patent application is based upon and claims the benefit of priority of Japanese Patent Application No. 2011-099919 filed on Apr. 27, 2011, the entire contents of which are incorporated herein by reference.

### BACKGROUND OF THE INVENTION

1. Field of the Invention

The present invention generally relates an antenna device and an electronic device.

As disclosed in Japanese Laid-open Patent Publication No. 2007-013643, an example of an antenna device has a ground pattern having a cut-off section formed at its end, a first radiating element arranged on one side of the cut-off section and equipped with a power feeder, and a second radiating element arranged on the other side of the cut-off section and equipped with a power feeder. As the first and second radiating elements, an inverted-F antenna is used, and the first radiating element and the second element are arranged symmetrically with respect to the cut-off section, so that the separation becomes maximal between positions where their respective radiation electric fields are the highest.

Since the example of the antenna device has a cut-off in the vicinity of the radiating element of the ground part, there is a case where a space is restricted in installing the antenna device to one apparatus together with electronic parts or the like. Therefore, the space may not be preferably saved.

Further, because of the above-described cut-off in the ground part, more parameters are to be considered to obtain good antenna characteristics, thereby causing a burden in designing the antenna device.

### SUMMARY OF THE INVENTION

Accordingly, embodiments of the present invention may provide a novel and useful antenna device and an electronic device solving one or more of the problems discussed above.

More specifically, the embodiments of the present invention may provide an antenna device including a ground part; a first stub connected to the ground part; a first inverted-F antenna element including a first power feeder; a second stub connected to the ground part; and a second inverted-F antenna element including a second power feeder, wherein the ground part has a linear part between a first connecting part between the first stub part and the ground part and a second connecting part between the second stub part and the ground part.

Additional objects and advantages of the embodiments are set forth in part in the description which follows, and in part will become obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1A is a perspective view of an electronic device including an antenna device of a first embodiment;

FIG. 1B is a perspective view of another electronic device including another antenna device of the first embodiment;

FIG. 2 is a plan view of the antenna device of the first embodiment;

FIG. 3 is an exploded perspective view of a board on which the antenna device of the first embodiment is mounted.

FIG. 4 is a graph illustrating frequency characteristics of VSWR of the antenna device of the first embodiment;

FIG. 5 is a graph illustrating frequency characteristics of an S parameter (S21) of the antenna device of the first embodiment;

FIG. 6A illustrates an antenna device of a modified example of the first embodiment;

FIG. 6B illustrates another antenna device of another modified example of the first embodiment;

FIG. 7A illustrates another antenna device of another modified example of the first embodiment;

FIG. 7B illustrates another antenna device of another modified example of the first embodiment;

FIG. 8 is a plan view of an antenna device of a second embodiment;

FIG. 9 is a graph illustrating frequency characteristics of VSWR of the antenna device of the second embodiment;

FIG. 10 is a graph illustrating frequency characteristics of an S parameter (S21) of the antenna device of the second embodiment;

FIG. 11 illustrates S parameters (S21) of the antenna devices of the first and second embodiments;

FIG. 12A illustrates an antenna device of a modified example of the second embodiment;

FIG. 12B illustrates another antenna device of another modified example of the second embodiment;

FIG. 13 illustrates another antenna device of another modified example of the second embodiment;

FIG. 14 is a plan view of an antenna device of a third embodiment;

FIG. 15A illustrates an antenna device of a modified example of the third embodiment;

FIG. 15B illustrates another antenna device of another modified example of the third embodiment;

FIG. 16 illustrates S parameters (S21) of the antenna devices of the third embodiment and the modified example of the third embodiment;

FIG. 17 is a plan view of an antenna device of a fourth embodiment;

FIG. 18 is an exploded perspective view of a board on which the antenna device of the fourth embodiment is mounted;

FIG. 19 illustrates an antenna device of a modified example of the fourth embodiment;

FIG. 20 is a graph for illustrating frequency characteristics of S parameters (S21) of antenna elements and a slot antenna of the antenna device of the modified example of the fourth embodiment;

FIG. 21A illustrates another antenna device of another modified example of the fourth embodiment;

FIG. 21B illustrates another antenna device of another modified example of the fourth embodiment;

FIG. 22A is a graph illustrating frequency characteristics of S parameters (S21) of the antenna device of the modified example of the fourth embodiment;

FIG. 22B is a graph illustrating frequency characteristics of S parameters. (S21) of the antenna device of the modified example of the fourth embodiment;

FIG. 23 is a plan view of an antenna device of a fifth embodiment; and

FIG. 24 is a graph illustrating frequency characteristics of an S parameter (S21) of the antenna device of the second embodiment.

### DETAILED DESCRIPTION OF THE PREFERRED EMBODIMENTS

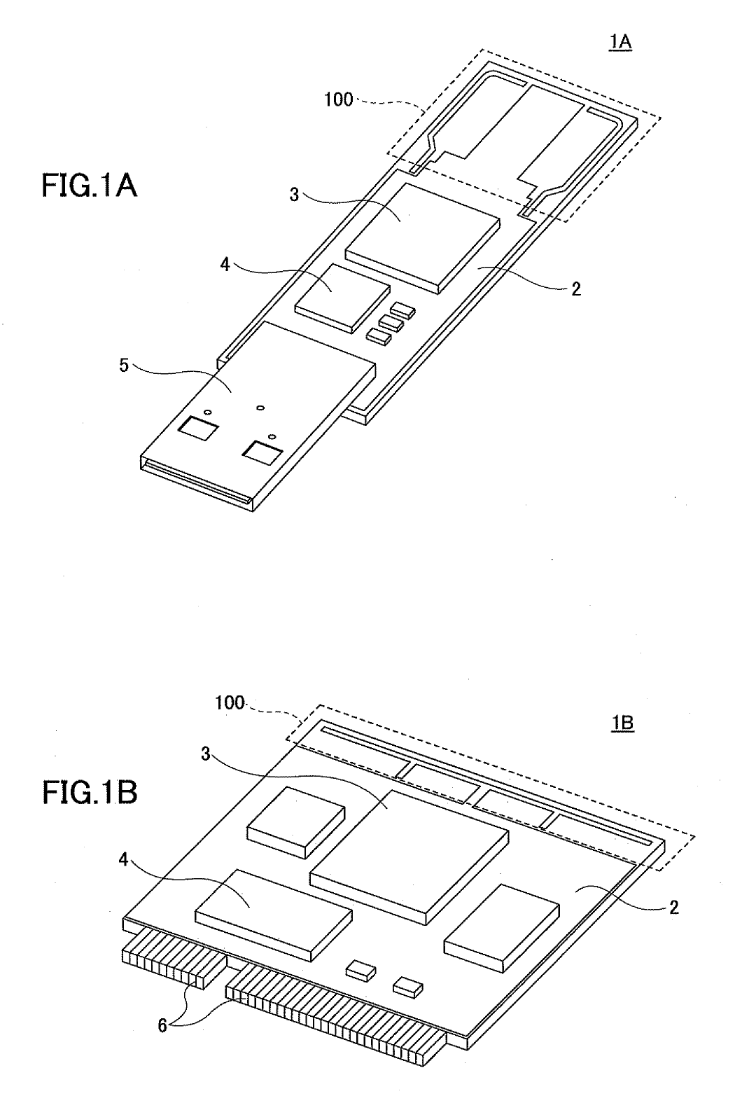

A description is given below, with reference to the FIG. 1 through FIG. 24 of embodiments of the present invention.

### [a] First Embodiment

FIG. 1A and FIG. 1B are perspective views of electronic devices including antenna devices of the first embodiment. FIG. 1A illustrates a Universal Serial Bus (USB) dongle 1A as one example of electronic device. FIG. 1B illustrates a Mini Peripheral Component Interconnect (Mini-PCT) card 1B as another example of electronic device. Referring to FIG. 1A and FIG. 1B, the inner structures are seen through for easier understanding.

A USB dongle 1A includes an antenna device 100, a board 2, a Radio Frequency (RF) communication device 3, a Micro Control Unit (MCU) chip 4, and a USB connector 5.

The antenna device 100 is formed on the board 2. For example, the board 2 is a multilayer board under the standard of Flame Retardant Type (FR4). The RF communication device 3, the MCU chip 4, and the USB connector 5 are mounted on the board 2.

The antenna device 100 is connected to the RF communication device 3 via a wiring of the board 2, and the RF communication device 3 is connected to the MCU chip 4 via the wiring of the board 2. The MCU chip 4 is connected to the RF communication device 3 and the USB connector 5 via the wiring of the board 2.

The USB dongle 1A is installed in a USB connector of a personal computer (PC) or the like. Under this state, the MCU chip 4 drives the RF communication device 3 to perform wireless communication via the antenna device 100 and the PC is connected to a wireless communication network, typically a wireless local area network (LAN).

The Mini-PCI card 1B illustrated in FIG. 1B includes an antenna device 100, a board 2, a RF communication device 3, a MCU chip 4, and a PCI connector 6. Referring to FIG. 1B, the antenna device 100, the board 2, the RF communication device 3, and the MCU chip 4 are similar to the antenna device 100, the board 2, the RF communication device 3, and the MCU chip 4 of the USB dongle 1A illustrated in FIG. 1A.

In the Mini-PCI card 1B, the MCU chip 4 is connected to the RF communication device 3 via a wiring of the board 2 and also connected to the PCI connector 6 via a wiring of the board 2.

For example, the Mini-PCI card 1B is installed in a peripheral component interconnect (PCI) connector of a PC or the like. Under this state, the MCU chip 4 drives the RF communication device 3 to perform wireless communication via the antenna device 100 and the PC is connected to a wireless communication network, typically a wireless local area network (LAN).

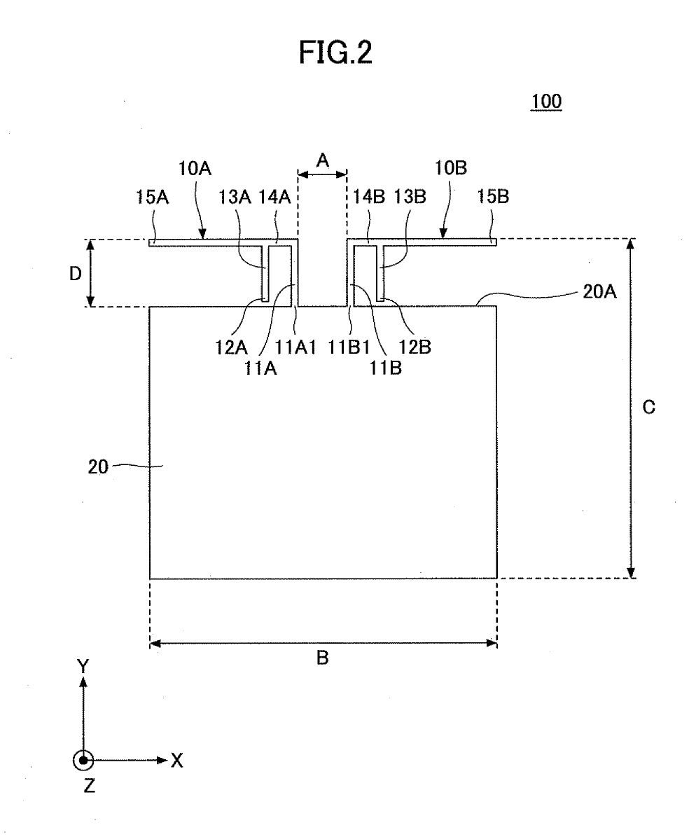

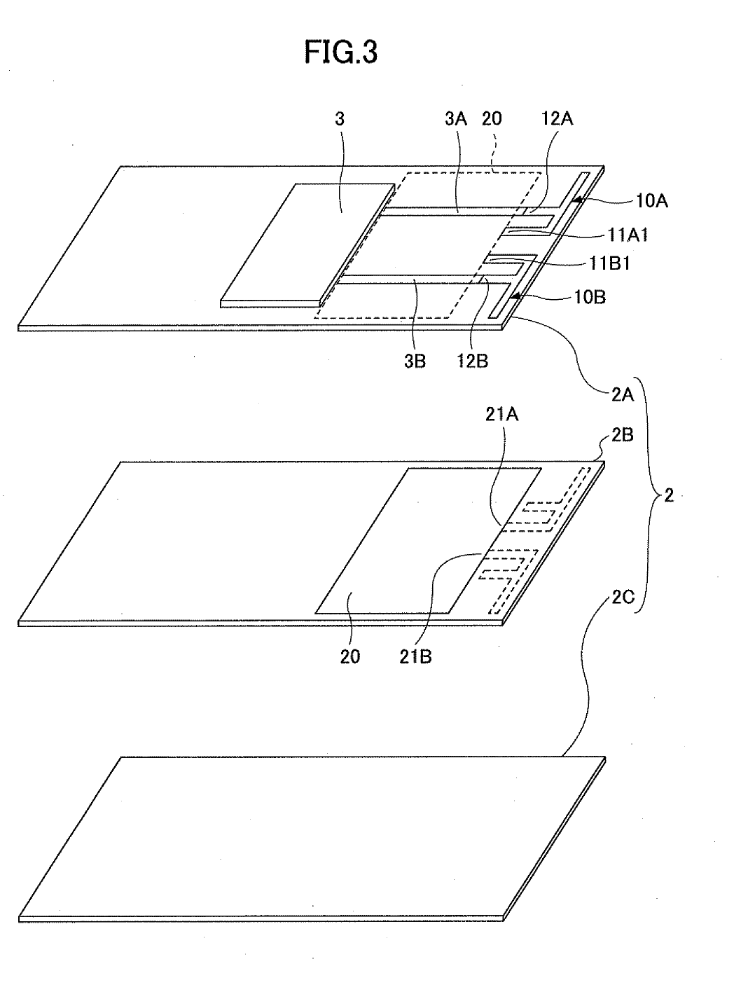

Referring to FIG. 2 and FIG. 3, the antenna device 100 of the first embodiment is described.

FIG. 2 is a plan view of the antenna device 100 of the first embodiment.

The antenna device 100 includes antenna elements 10A and 10B and a ground element 20. For example, the antenna elements 10A and 10B and the ground element 20 are formed by patterning a copper foil.

The antenna device 100 is formed in the board 2. A mounted state of the antenna device 100 on the board 2 is described later with reference to FIG. 3. Referring to FIG. 2, patterns of the antenna elements 10A and 10B and the ground element 20 are described.

Within FIG. 2, an X-axis is in a lateral direction, a Y-axis is in a longitudinal direction, and a Z-axis is in a vertical direction. The positive values on the X axis and the Y axis are on the side of the arrows of FIG. 2. The positive value on the Z axis is on the near side of a viewer from FIG. 2.

The antenna elements 10A and 10B are bilaterally symmetric as illustrated in FIG. 2.

The antenna element 10A is an example of a first antenna element. The antenna element 10A includes a short stub 11A connected to the ground element 20, a power feeder 12A, a power feeding line 13A, a line 14A, and an end part 15A.

An end 11A1 of the short stub 11A is connected to the ground element 20. The power feeder 12A is close to the ground element 20.

Electric power is supplied from a communication device. The short stub 11A, the power feeding line 13A, and the line 14A form an antenna element 10A in an inverted-F shape.

Hereinafter, the frequency of an electromagnetic wave to be used for sending from and receiving by an antenna element is referred to as a “frequency for use”. The length between the end 11A1 where the short stub 11A is connected to the ground element 20 and an open end 15A is set to be about one fourth of the wavelength λ (λ/4) of the frequency for use, i.e., the frequency of an electromagnetic wave to be used for sending from and receiving by the antenna element 10A. The length between an end 11B1 of the antenna element 10B and the open end 15B is similar.

The line 14A extends or protrudes parallel to an edge part 20A of the ground element 20. The short stub 11A and the power feeding line 13A extends or protrudes in a direction perpendicular to the edge part 20A.

The end part 15A is an open end of the line 14A which forms an open end of the antenna element 10A in the inverted-F shape (the inverted-F Antenna).

The antenna element 10B is an example of a first antenna element. The antenna element 10B includes a short stub 11B connected to the ground element 20, a power feeder 12B, a power feeding line 13B, a line 14B, and an end part 158.

An end 11B1 of the short stub 11B is connected to the ground element 20. The power feeder 12B is close to the ground element 20. Electric power is supplied from the communication device. The short stub 11B, the power feeding line 13B, and the line 14B form an antenna element 10B in an inverted-F shape.

The line 14B extends or protrudes parallel to the edge part 20A of the ground element 20. The short stub 11B and the power feeding line 13B extends or protrudes in the direction perpendicular to the edge part 20A.

The end part 15B is an open end of the line 14B which forms an open end of the antenna element 10B in the inverted-F shape (the inverted-F Antenna).

The antenna element 10B and the antenna element 10A are bilaterally symmetric. The short stubs 11A and 11B are arranged in parallel with a gap A.

The directions of polarization of the antenna elements 10A and 10B are plus and minus directions in the Y axis.

If the wavelength is designated by λ, the gap A is preferably λ/20 or smaller of the frequency for use. The reason why is described later.

The ground element 20 is an example of a ground part and patterned to be shaped like a rectangle. The width B of the ground element 20 in the lateral direction along the X axis is, for example, 30 mm, and the length C of the ground element 20 in the longitudinal direction along the Y axis is, for example, 24 mm. The distances between the edge part 20A and the upper ends of the lines 14A and 14B is, for example, 2.5 mm. These are values in case where the frequency for use is 2.45 GHz.

In a case where the frequency for use is 2.45 GHz, the gap A between the short stubs 11A and 11B becomes about 5 mm. The line widths of the short stubs 11A and 11B, the power feeding lines 13A and 13B, and the lines 14A and 14B are, for example, 0.5 mm.

Referring to an exploded perspective view of FIG. 3, a mode of mounting the antenna device 100 on the board 2 (see FIG. 1A and FIG. 1B) is described.

FIG. 3 is an exploded perspective view of a board on which the antenna device of the First Embodiment is mounted. Referring to FIG. 3, the reference symbol 100 designating the antenna device is not illustrated. However, all constructional elements of the antenna device of FIG. 2 are illustrated.

The board 2 is called a 4-layer board including four copper foil layers and three insulating layers 2A to 2C. FIG. 3 illustrates two layers of the four copper layers, i.e., a first layer formed on a surface of the insulating layer 2A and a second layer formed between the insulating layers 2A and 2B.

For example, the insulating layers 2A and 2B are prepreg layers, and the insulating layer 2B is a core layer containing a glass epoxy material.

Referring to FIG. 3, description is given for easier understanding on a premise that the first layer (the antenna elements 10A and 10B or the like) is patterned on the surface of the insulating layer 2A and the second layer (the ground element 20 or the like) is patterned on the upper surface of the insulating layer 2B.

The four copper foil layers and the three insulating layers 2A to 2C undergo thermal compression so as to be formed as the board 2 having the antenna device 100.

The antenna elements 10A and 10B are formed on the insulating layer 2A and the RF communication device 3 is mounted on the insulating layer 2A. The power feeders 12A and 12B are formed so as to receive electric power from the RF communication device 3 via microstriplines 3A and 3B.

The ground element 20 is formed on the insulating layer 2B. The location of the ground element 20 on the insulating layer 2A is indicated by a broken line. Locations of the antenna elements 10A and 10B on the insulating layer 2B are indicated by broken lines.

Although the shape of the ground element 20 is rectangular in FIG. 3, it is sufficient that the ground element 20 is shaped so that the edge part 20A of the ground element 20 between the end 11A1 of the short stub 11A and the end 11B1 of the short stub 11B is shaped like a straight line. Said differently, the sides other than the edge part 20A may not always be linear. The ground element 20 may be patterned so as not to interfere with a via being an interlayer wiring.

Referring to FIG. 3, the copper foil layers provided in both surfaces of the insulating layer 2C are omitted. On the upper surface and the lower surface of the insulating layer 2C, a power source layer and a signal layer are respectively formed.

The end 11A1 of the short stub 11A of the antenna element 10A is connected to connecting part 21A of the ground element by a via penetrating the insulating layer 2A in its thickness direction.

Similarly, the end 11B1 of the short stub 11B of the antenna element 10B is connected to connecting part 21B of the ground element by a via penetrating the insulating layer 2A in its thickness direction.

The RF communication device 3 is connected to the ground element 20 formed on the insulating layer 2B via an interlayer wiring (not illustrated).

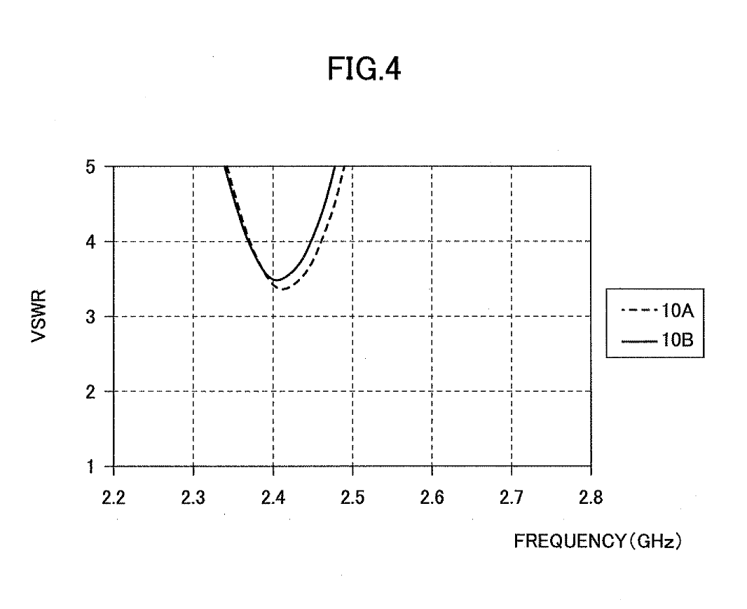

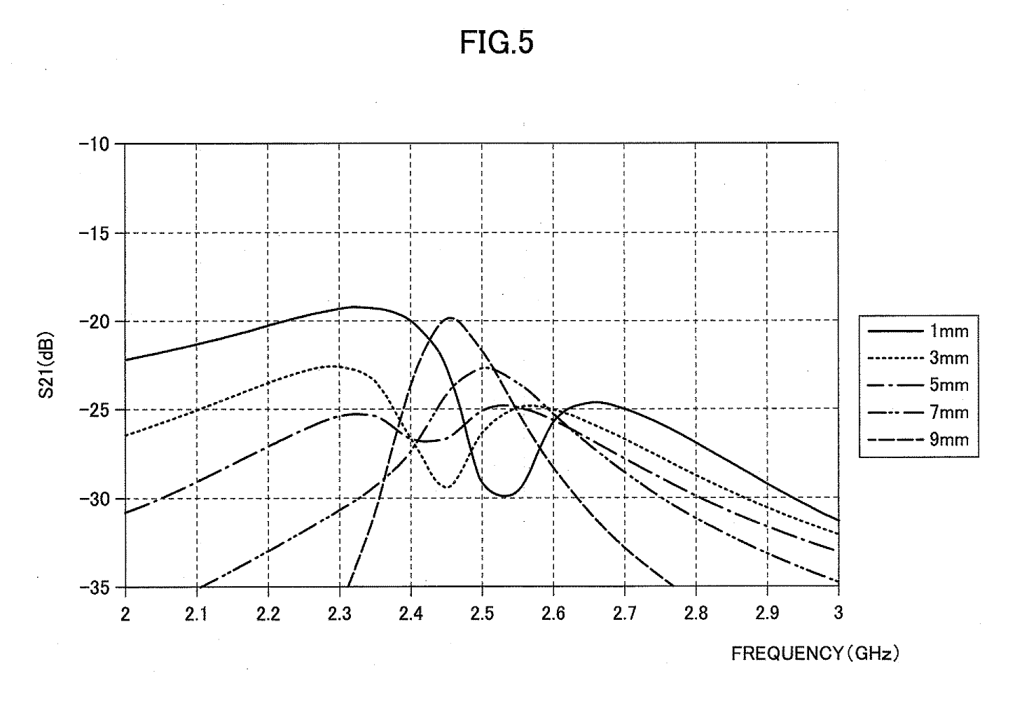

Referring to FIG. 4 and FIG. 5, frequency characteristics of the voltage standing wave ratio (VSWR) and the S parameter (S21) of the antenna device 100 of the first embodiment are described.

FIG. 4 is a graph illustrating frequency characteristics of VSWR of the antenna device 100 of the first embodiment.

As illustrated in FIG. 4, the local minimal values (or the minimum values) of about 3.5 is obtained at 2.45 GHz being a frequency for use in the antenna elements 10A and 10B.

With this, it is known that the antenna device 100 is suitable for wireless communication in a band frequency of 2.45 GHz.

FIG. 5 is a graph illustrating frequency characteristics of the S parameter (S21) of the antenna device of the first embodiment.

The S parameter (S21) illustrated in FIG. 5 represents an insertion loss obtained at a time of communicating between the antenna element 10A and the antenna element 10B. Said differently, when communication is performed between the antenna element 10A and the antenna element 10B, the insertion loss (S21 among the S parameters) is obtained in the power feeder 12A or 12B.

Further, the characteristics of five lines in FIG. 5 are S parameters (S21) obtained in the antenna devices 100 of which the gap A between the short stubs 11A and 11B are changed.

The S parameters (S21) of the five antenna devices 100 having the gaps of 1 mm, 3 mm, 5 mm, 7 mm and 9 mm are obtained by simulation.

As a result, in all cases, a relatively good value of about −20 dB or smaller is obtained at around 2.45 GHz being the frequency for use. However, in a case where the gap A is 7 mm or 9 mm, the S parameter (S21) becomes locally maximal (maximum) at around 2.45 GHz.

On the contrary, in a case where the gap A is 1 mm, 3 mm or 5 mm, the local minimal values (or the minimum values) are obtained at around 2.45 GHz. Especially, when the gap A is 3 mm, a very good S parameter (S21) of about −29 dB is obtainable.

Although it is not illustrated in FIG. 5, when the gap A is set to be 6 mm, it is possible to obtain a good characteristic where the local minimal value (or the minimum value) is obtainable at around 2.45 GHz. The result is similar to the case where the gap A is set to be 5 mm.

As described, in the case where the gap A is relatively narrow up to about 6 mm, the S parameter (S21) becomes good, and in the case where the gap A is relatively wide such as about 7 mm or greater, the S parameter (S21) does not have the local minimal value (or the minimum value) at around 2.45 GHz.

As described, the reason why the S parameter (S21) becomes good in the case where the gap A is relatively narrow up to about 6 mm is presumably reduction of interference between the two antenna elements 10A and 10B.

The wavelength λ of the frequency of 2.45 GHz is about 120 mm. Since it is known that the gap A is preferably 6 mm or smaller, the gap A is preferably λ/20 or smaller.

Therefore, within the first embodiment, the inverted-F antennas 10A and 10B are bilaterally symmetrically arranged so that the short stubs 11A and 11B are adjacent each other, the edge part 20A between the end 11A1 of the short stub 11A and the end 11B1 of the short stub 11B are shaped like a straight line, and the gap A between the short stubs 11A and 11B is set to be λ/20 or smaller, it is possible to reduce the interference between the two inverted-F antenna elements 10A and 10.

The antenna device 100 can be used for communication for wireless LAN or a diversity antenna. By using a plurality of such antenna devices 100, a multiple input multiple output (MIMO) communication such as WiMAX (“WiMAX” is a registered trademark) can be realized.

As described, in the antenna device 100 of the first embodiment, the edge part 20A of the ground element 20 between the end 11A1 of the short stub 11A and the end 11B1 of the short stub 118 is shaped like a straight line.

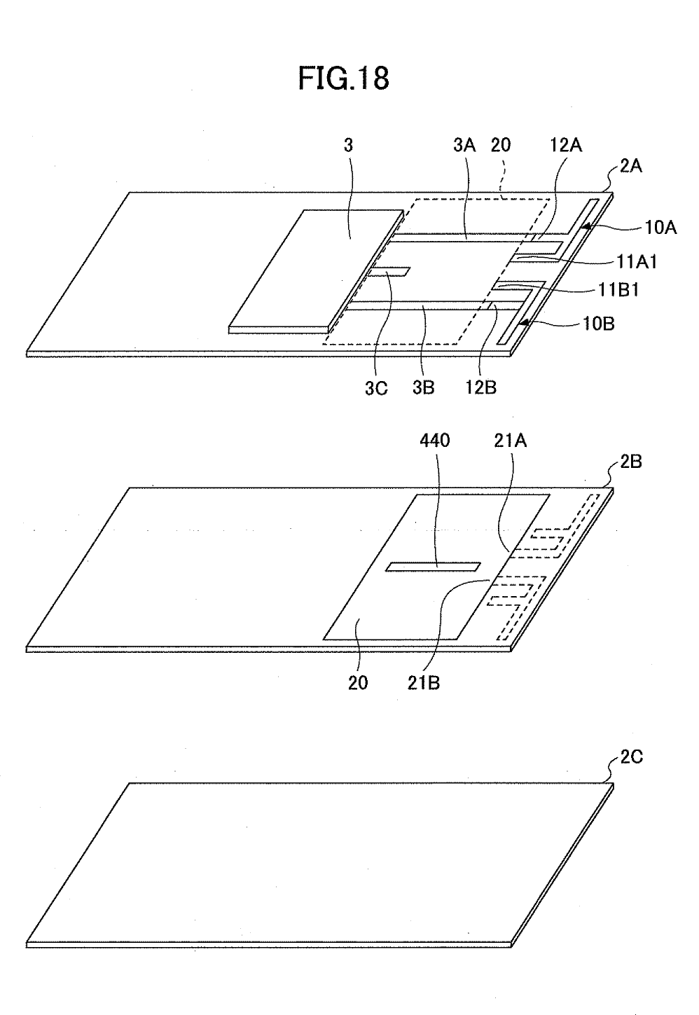

Therefore, in a case where the antenna device 100 is mounted on one electronic device such as a USB dongle 1A and a Mini-PCI card 1B (see FIG. 1A and FIG. 18) together with the RF communication device 3 and the MCU chip 4, spacial limitation is scarcely caused at the edge part 20A of the ground element 20. For example, since the RF communication device 3 can be arranged along the edge part 20A, the space can be saved.

In comparison with the above-described example antenna device in which the cut-off section is formed in the ground part, a parameter to be considered to in order to obtain good antenna characteristics is reduced by the cut-off section. Therefore, a burden in designing the antenna device 100 is reduced.

As described, since the edge part 20A of the ground element 20 between the end 11A1 of the short stub 11A and the end 11B1 of the short stub 11B is shaped like a straight line in the antenna device 100 of the first embodiment, it is possible to provide the antenna device 100 which can be easily designed.

With the antenna device 100 of the first embodiment, the frequency for use can be adjusted by adding a parasitic element or an inductor to thereby adjust the frequency for use.

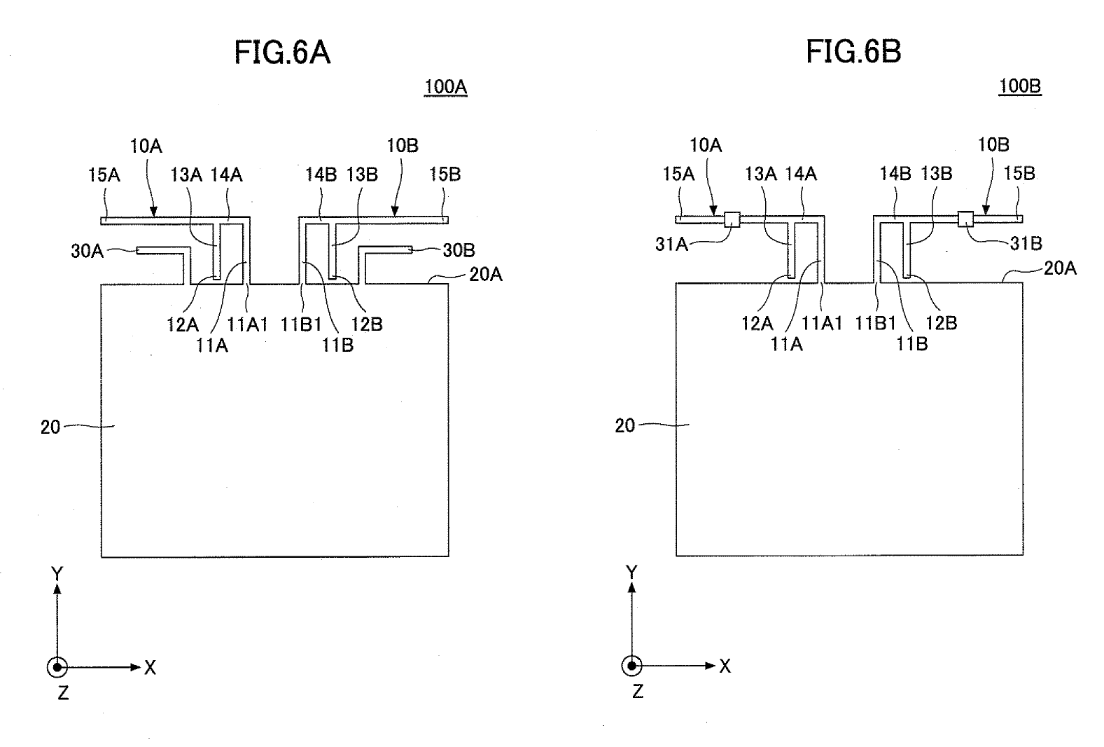

FIG. 6A and FIG. 6B illustrate antenna devices of a modified example of the first embodiment.

Referring to FIG. 6A, the antenna device 100A is formed by adding parasitic elements 30A and 30B positioned outside power feeding lines 13A and 13B of inversed-F antenna elements 10A and 10B in lateral directions along an X axis to the antenna device 100 illustrated in FIG. 2. The parasitic elements 30A and 30B are connected to the edge part 20A of the ground element 20, and electromagnetically coupled to the antenna elements 10A and 10B.

The lengths of the parasitic elements 30A and 30B are set to be approximately one fourth of the wavelength λ of 5 GHz.

Therefore, if the electromagnetic power having a frequency of 2.45 GHz is supplied to the power feeder 12A, the inverted-F antenna element 10A is excited to thereby emit electromagnetic waves. When the electric power having a frequency of 5 GHz is supplied to the power feeder 12A, the parasitic element 30A is excited via the antenna element 10A to thereby emit electromagnetic waves from the parasitic element 30A. When the electric power having a frequency of 2.45 GHz or 5 GHz is supplied to the power feeder 12B, the parasitic element 30B is excited via the antenna element 10B to thereby emit electromagnetic waves from the parasitic element 30B.

Therefore, by adding the parasitic elements 30A and 30B to the antenna elements 10A and 10B, the dual band antenna device 100A having two frequencies for use can be realized.

An antenna device illustrated FIG. 6B is obtained by inserting inductor chips 31A and 31B into lines 14A and 14B of the antenna device 100 illustrated in FIG. 2.

By inserting the inductors into the lines 14A and 14B of the antenna elements 10A and 10B, respectively, the frequency for use can be substantially shifted to a lower frequency side. Said differently, the line length can be elongated. Therefore, if the same frequencies for use are used, the lines 14A and 14B can be shortened. Therefore, the antenna device 100B becomes smaller than the antenna device 100.

When the inductor chips 31A and 31B are inserted in the lines 14A and 14B, it is possible to adjust the frequency for use and miniaturize the antenna device 100B.

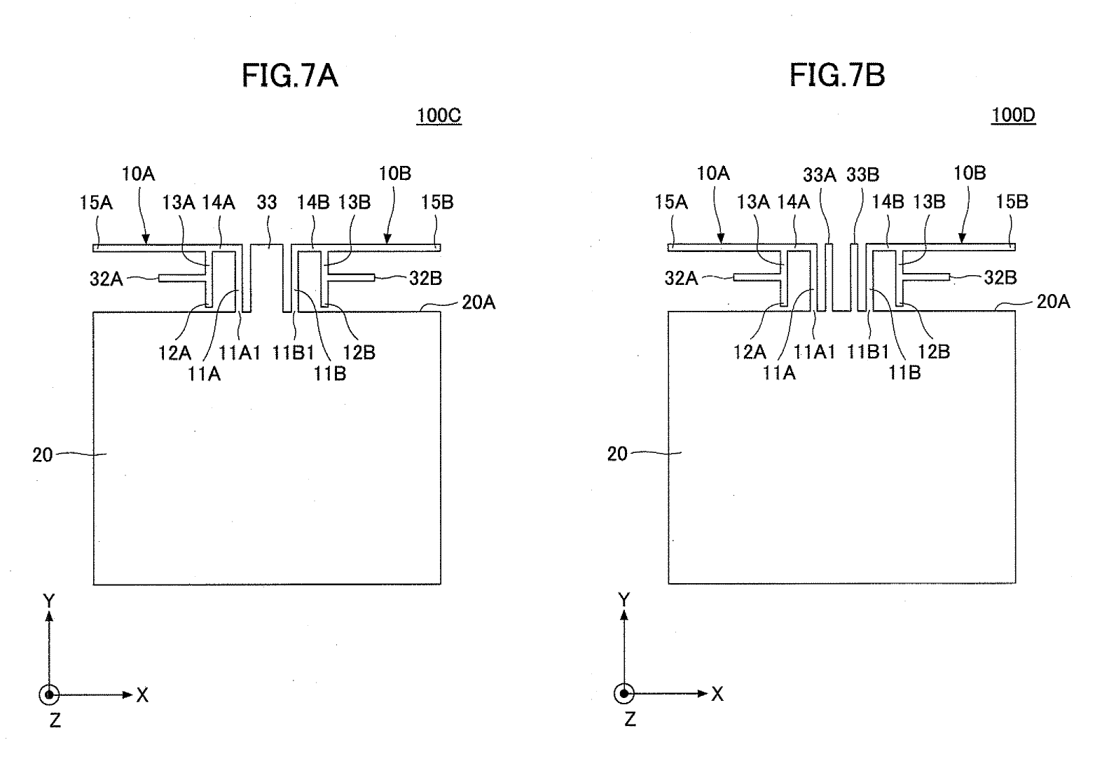

FIG. 7A and FIG. 7B illustrate antenna devices of another modified example of the first embodiment.

The antenna device illustrated in FIG. 7A is obtained by adding antenna elements 32A and 32B and extending ground part 33 to the antenna device illustrated in FIG. 2.

The antenna elements 32A and 32B are connected to the power feeding lines 13A and 13B, respectively. The antenna elements 32A and 32B are formed to outward extend in the X directions of the antenna device 100C along an edge part 20A of the ground element 20.

The lengths of the antenna elements 32A and 32B are set to be approximately one fourth of the wavelength λ of 5 GHz.

Therefore, if the electric power having a frequency of 2.45 GHz is supplied to the power feeder 12A, the inverted-F antenna element 10A is excited to thereby emit electromagnetic waves. When the electric power having a frequency of 5 GHz is supplied to the power feeder 12A, the parasitic element 32A is excited via the antenna element 10A to thereby emit electromagnetic waves from the antenna element 32A. When the electric power having a frequency of 2.45 GHz or 5 GHz is supplied to the power feeder 12B, the antenna element 32B is excited via the antenna element 10B to thereby emit electromagnetic waves from the antenna element 32B.

The extending ground part 33 is connected to the ground element 20 between short stubs 11A and 11B and extends or protrudes in a positive direction along a Y axis from the end part 20A of the ground element 20.

Therefore, the antenna device 100C becomes a dual band antenna device having two frequencies for use by adding the antenna elements 32A and 32B. Further, by adding the extending ground part 33, a coupling state between the antenna elements 10A and 10B and the ground element 20 can be adjusted. Therefore, frequency characteristics of the antenna device 100C can be adjusted.

Meanwhile, by inserting the inductor chips 31A and 31B into the lines 14A and 14B of the antenna elements 10A and 10B of the antenna device 100C illustrated in FIG. 7A, respectively, the antenna device 100C can be miniaturized.

The antenna device illustrated in FIG. 7B is obtained by adding antenna elements 33A and 33B and extending ground parts 33A and 33B to the antenna device illustrated in FIG. 2.

The antenna elements 32A and 32B are similar to the antenna elements 32A and 32B.

The extending ground parts 33A and 33B are connected to a ground element 20 between short stubs 11A and 11B and extend in a positive direction along a Y axis from an end part 20A of the ground element 20.

Therefore, the antenna device 1000 becomes a dual band antenna device having two frequencies for use by adding the antenna elements 32A and 32B. Further, by adding the extending ground part 33, a coupling state between the antenna elements 10A and 10B and the ground element 20 can be adjusted. Therefore, frequency characteristics of the antenna device 100D can be adjusted.

Meanwhile, by inserting inductor chips 31A and 31B into lines 14A and 14B of antenna elements 10A and 10B of the antenna device 100D illustrated in FIG. 7B, respectively, the antenna device 100D can be miniaturized.

### [b] Second Embodiment

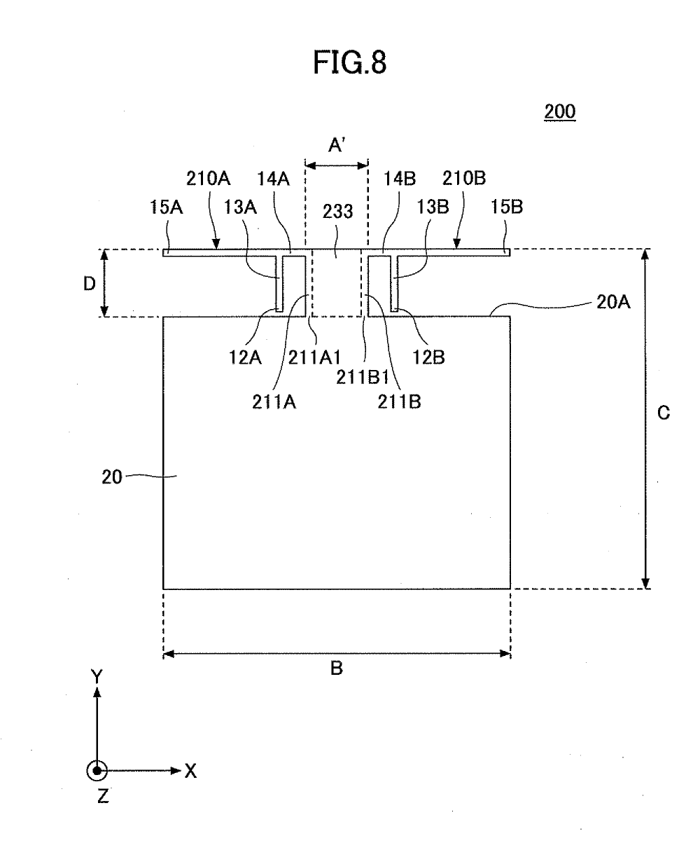

FIG. 8 is a plan view of the antenna device 200 of the second embodiment.

An antenna device 200 has a structure of extending the extending ground part 33 of the antenna device 100C (see FIG. 7A) of the modified example of the first embodiment in the X direction to thereby integrate the extending ground part 33 in the short stubs 11A and 11B. Because the other portions are the same as the antenna device 100 of the first embodiment, the same reference symbols are attached to those and description is omitted.

The antenna device 200 of the second embodiment includes antenna elements 210A and 210B and a ground element 20.

Further, an extending ground part 233 is provided between the short stubs 211A and 211B of the antenna elements 210A and 210B. The short stub 211A, the extending ground part 233, and the short stub 211B are integrated. It can be determined that the short stubs 211A and 211B are widened to integrate the extending ground part 233.

As described, even if the extending ground part 233 is provided, a linear part (a straight line) may be included or virtually exists, as illustrated by the lateral broken line in FIG. 8, between ends 211A1 and 211B1 for connecting the short stubs 211A and 211B to the ground element 20.

With the antenna device 100 of the first embodiment, the antenna characteristics in which the gap A between the insides of the short stubs 11A and 11B (see FIG. 2) is changed. Within the second embodiment, antenna characteristics are evaluated by changing an outer dimension A′ between the short stubs 211A and 211B.

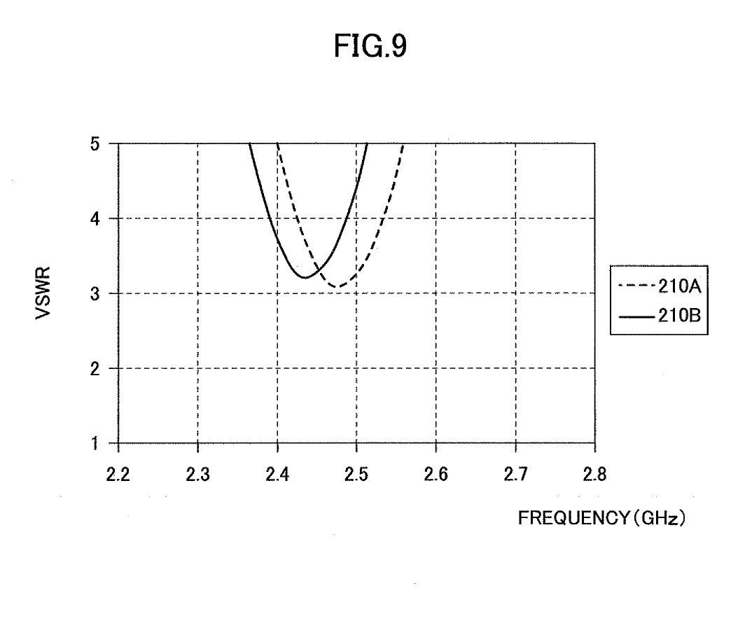

FIG. 9 is a graph illustrating frequency characteristics of VSWR of the antenna device 200 of the second embodiment.

As illustrated in FIG. 9, the local minimal values (or the minimum values) of about 3.2 are obtained at 2.45 GHz being a frequency for use in the antenna elements 210A and 210B.

With this, it is known that the antenna device 200 is suitable for wireless communication in a band frequency of 2.45 GHz.

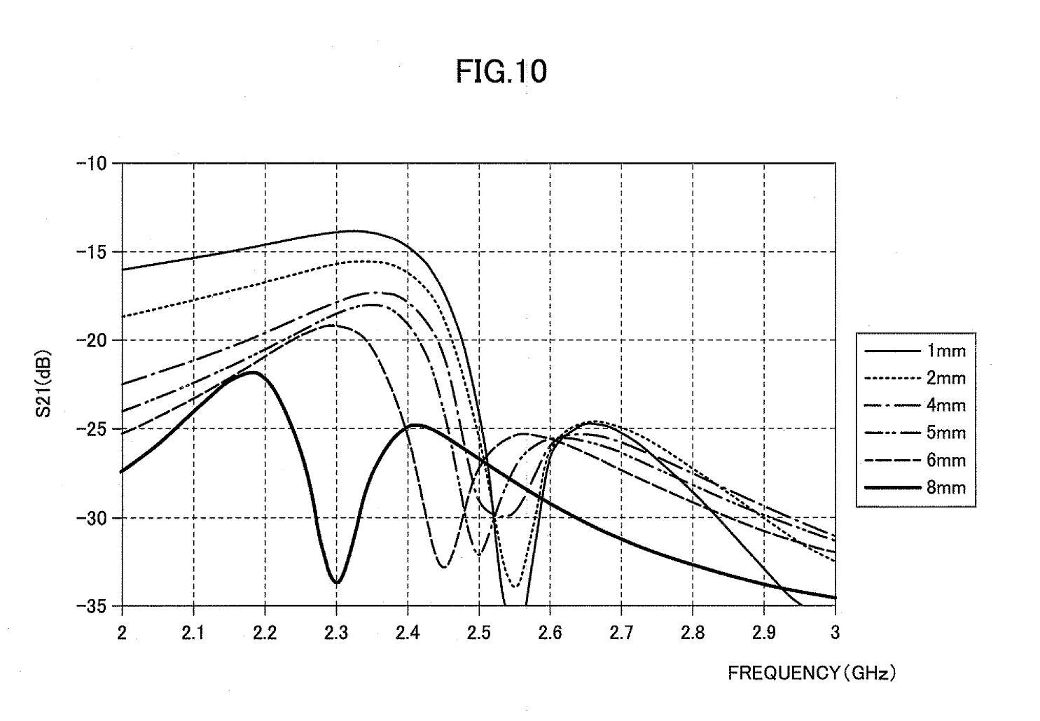

FIG. 10 is a graph illustrating frequency characteristics of the S parameter (S21) of the antenna device 200 of the second embodiment.

The S parameter (S21) illustrated in FIG. 10 represents an insertion loss obtained at a time of communicating between the antenna element 210A and the antenna element 210B. Said differently, when communication is carried out between the antenna element 210A and the antenna element 210B, the insertion loss (S21 among the S parameters) is obtained in the power feeder 12A or 12B.

Further, the characteristics of five lines in FIG. 10 are S parameters (S21) obtained in the antenna devices 200 of which the dimension A between the short stubs 211A and 211B are changed.

The S parameters (S21) of the six antenna devices 200 having the dimensions of 1 mm, 2 mm, 4 mm, 5 mm, 6 mm and 8 mm are obtained by simulation.

As a result, if the dimension A′ is 1 mm, 2 mm, or 4 mm, the S parameters (S21) become the local minimal values (or the minimum values) in the vicinity of 2.5 GHz. If the dimension A′ is 5 mm or 6 mm, the S parameters (S21) become relatively good values of about −25 dB or smaller in the vicinity of 2.5 GHz. If the dimension A′ is 1 mm, 2 mm, or 4 mm, the S parameters (S21) become the local minimal values (or the minimum values) in the vicinity of 2.3 GHz.

As described, in the antenna device 200 having the extending ground part 233 between the short stubs 211A and 211B, the S parameter (S21) becomes good in the case where the dimension A′ is about 5 to 6 mm.

As described, the reason why the S parameter (S21) becomes good in the case where the dimension A′ is relatively narrow up to about 6 mm is presumably because of reduction of interference between the two antenna elements 210A and 210B.

The wavelength λ of the frequency of 2.45 GHz is about 120 mm. Further, it is known that the dimension A′ is preferably 6 mm. Therefore, in the antenna device 200 having the extending ground part 233 between the short stubs 211A and 211B of the antenna elements 210A and 210B, the dimension A′ is preferably about λ/20.

As described, within the second embodiment, it is possible to provide the antenna device 200 with the reduced interference between the two inverted-F antenna elements 210A and 210B by providing the extending ground part 233 between the short stubs 211A and 211B of the antenna elements 210A and 210B and setting the dimension A′ of the short stubs 211A and 211B to be about λ/20 where λ designates the wavelength of the frequency for use.

The antenna device 200 can be used for communication for wireless LAN or a diversity antenna. By using a plurality of such antenna devices 200, a multiple input multiple output (MIMO) communication such as WiMAX (“WiMAX” is the registered trademark) can be realized.

Further, as described, the antenna device 200 of the second embodiment 200 includes the ground element 20 shaped like the straight line between the ends 211A and 211B of the short stubs 211A and 211B and the extending ground part 233 protruding from the straight line.

Therefore, in a case where the antenna device 200 is mounted on one electronic device such as the USB dongle 1A and the Mini-PCI card 1B (see FIG. 1A and FIG. 1B) together with the RF communication device 3 and the MCU chip 4, spacial limitation is scarcely caused at the edge part 20A of the ground element 20. For example, since the RF communication device 3 can be arranged along the edge part 20A, the space can be saved.

In comparison with the above-described example antenna device in which the cut-off section is formed in the ground part, a parameter to be considered in order to obtain good antenna characteristics is reduced by the cut-off section. Therefore, a burden in designing the antenna device 200 is reduced.

As described, since the edge part 20A of the ground element 20 between the end 211A1 of the short stub 211A and the end 211B1 of the short stub 211B is shaped like the straight line in the antenna device 200 of the second embodiment and the extending ground part 233 extending from the straight line is provided, it is possible to provide the antenna device 200 which can be easily designed.

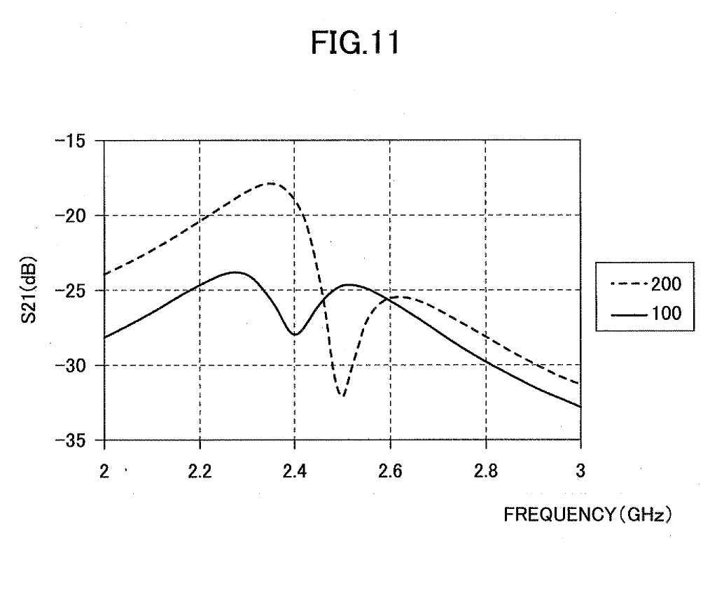

Referring to FIG. 11, the S parameter (S21) of the antenna device 100 of the first embodiment and the S parameter (S21) of the antenna device 200 of the second embodiment are compared.

FIG. 11 illustrates S parameters (S21) of the antenna device 100 of the first embodiment and the antenna device 200 of the second embodiment. FIG. 11 illustrates the S parameter (S21) of the antenna device 100 in the case where the gap A is 5 mm using a solid line, and the S parameter (S21) of the antenna device 200 in the case where the interval A′ is 6 mm using a broken line.

Since the line widths of the short stubs 11A, 11B, 211A and 211B and of the lines 14A and 14B are 0.5 mm, the gap between the short stubs 11A and 11B of the antenna device 100 and the gap between the short stubs 211A and 211B of the antenna device 200 are the same.

As illustrated in FIG. 11, it is known that the frequency characteristics of the antenna devices 100 and 200 are different. Although the local minimal value (or the minimum value) of the S parameter in the antenna device 100 is higher than that in the antenna device 200, the frequency characteristics are more flat than these of the antenna device 200. On the other hand, the local minimal value (or the minimum value) of the antenna device 200 is lower than that in the antenna device 100, the frequency characteristics are more abrupt than these of the antenna device 100.

As described, since the frequency characteristics can be adjusted using the extending ground part 233, it is determined whether the extending ground part 233 is provided in response to the use and the frequency for use.

With the antenna device 200 of the second embodiment, the frequency for use can be adjusted by adding a parasitic element or an inductor to thereby adjust the frequency for use.

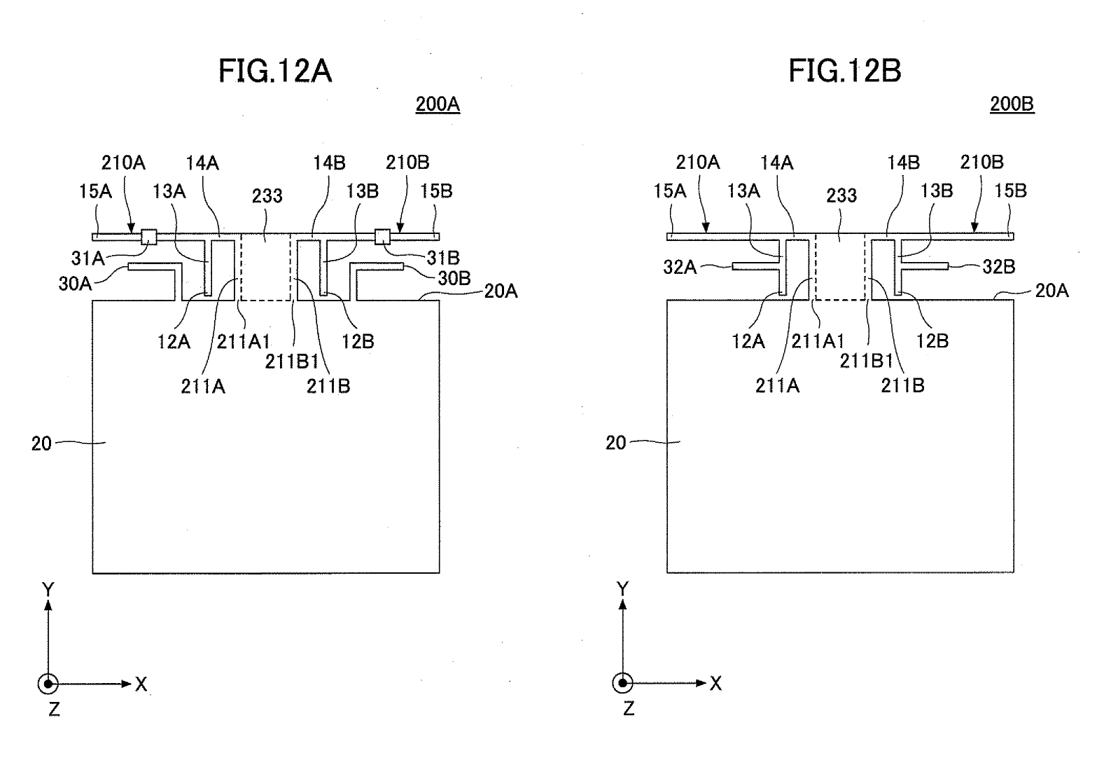

FIG. 12A and FIG. 12B illustrate antenna devices of a modified example of the second embodiment.

Referring to FIG. 12A, an antenna device 200A is formed by adding parasitic elements 30A and 30B positioned outside power feeding lines 13A and 13B of inversed-F antenna elements 210A and 210B in lateral directions along an X axis and inductor chips 31A and 31B to the lines 14A and 14B to the antenna device 200 illustrated in FIG. 8. The parasitic elements 30A and 30B are connected to an edge part 20A of a ground element 20, and electromagnetically coupled to the antenna elements 210A and 210B.

The lengths of the parasitic elements 30A and 30B are set to be approximately one fourth of the wavelength λ of 5 GHz.

The inductor chips 31A and 31B are inserted into the lines 14A and 14B of the antenna elements 210A and 210B.

By inserting inductors into the lines 14A and 14B of the antenna elements 210A and 210B, respectively, the frequency for use can be substantially shifted to a lower frequency side. Said differently, the line length can be elongated. Therefore, if the same frequency for use is used, the lines 14A and 14B can be shortened. Therefore, the antenna device 200A becomes smaller than the antenna device 200.

Therefore, if power of 2.45 GHz is supplied to the power feeder 12A, the inverted-F antenna element 210A is excited to thereby emit electromagnetic waves. When the electric power having a frequency of 5 GHz is supplied to the power feeder 12A, the parasitic element 30A is excited via the antenna element 210A to thereby emit electromagnetic waves from the parasitic element 30A. When the electric power having a frequency of 2.45 GHz or 5 GHz is supplied to the power feeder 12B, the parasitic element 30B is excited via the antenna element 210B to thereby emit electromagnetic waves from the parasitic element 30B.

When the inductor chips 31A and 31B are inserted in the lines 14A and 14B, it is possible to adjust the frequency for use and miniaturize the antenna device 200A.

Therefore, by adding the parasitic elements 30A and 30B to the antenna elements 210A and 210B, the dual band antenna device 200A having two frequencies for use can be realized.

However, the antenna device 200A illustrated in FIG. 12A may not include the inductor chips 31A and 31B.

The antenna device 200B illustrated in FIG. 12A is obtained by adding antenna elements 32A and 32B to the antenna device 200 illustrated in FIG. 8.

The antenna elements 32A and 32B are connected to the power feeding lines 13A and 13B, respectively. The antenna elements 32A and 32B are formed to outward extend in the X directions of the antenna device 200C along an edge part 20A of the ground element 20.

The lengths of the antenna elements 32A and 32B are set to be approximately one fourth of the wavelength λ of 5 GHz.

Therefore, if power of 2.45 GHz is supplied to the power feeder 12A, the inverted-F antenna element 210A is excited to thereby emit electromagnetic waves. When the electric power having a frequency of 5 GHz is supplied to the power feeder 12A, the antenna element 32A is excited via the antenna element 210A to thereby emit electromagnetic waves from the antenna element 32A. When electric power having a frequency of 2.45 GHz or 5 GHz is supplied to the power feeder 12B, the antenna element 32B is excited via the antenna element 210B to thereby emit electromagnetic waves from the antenna element 32B.

Therefore, the antenna device 200B becomes a dual band antenna device having two frequencies for use by adding the antenna elements 32A and 32B.

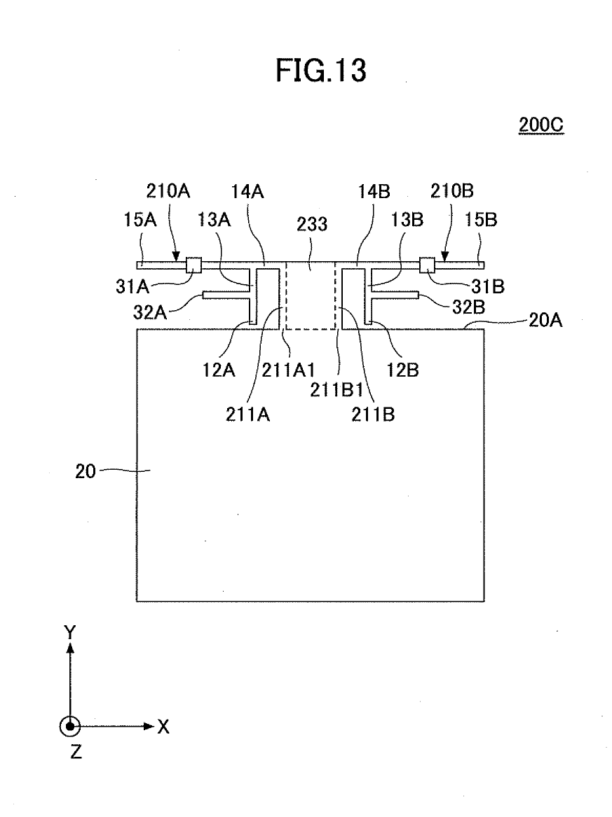

FIG. 13 illustrates an antenna device 200C of another modified example of the second embodiment.

The antenna device 200C illustrated FIG. 13 is obtained by inserting inductor chips 31A and 31B into the lines 14A and 14B of the antenna device 200B illustrated in FIG. 12.

By inserting inductors into the lines 14A and 14B of the antenna elements 210A and 210B, respectively, the frequency for use can be substantially shifted to a lower frequency side. Said differently, the line length can be elongated. Therefore, if the same frequency for use is used, the lines 14A and 14B can be shortened. Therefore, the antenna device 200C becomes smaller than the antenna device 200B.

### [c] Third Embodiment

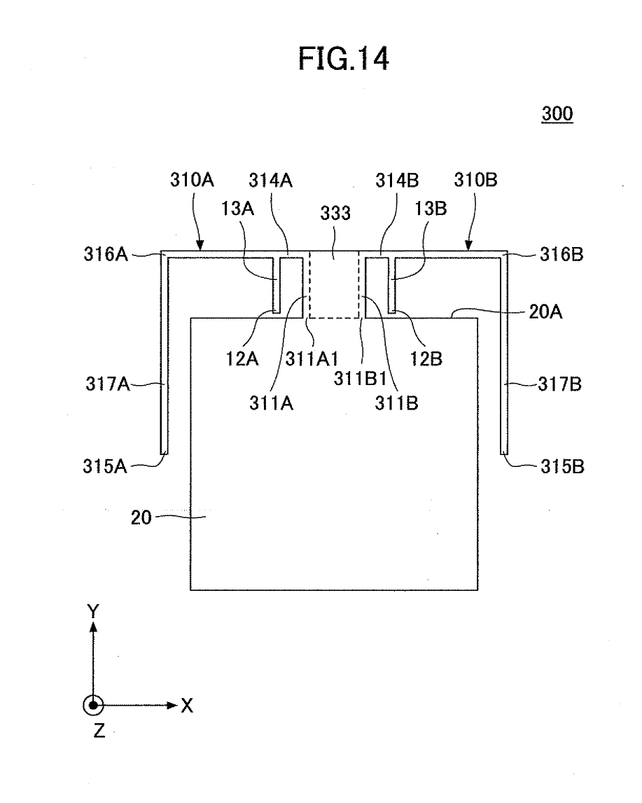

FIG. 14 is a plan view of an antenna device 300 of the third embodiment.

The antenna device 300 of the third embodiment is obtained by slightly extending the lines 14A and 14B of the antenna device 200 (see FIG. 8) of the second embodiment in an X direction and connecting the lines 317A and 317B extending in a negative direction along a Y axis. Because the other portions are the same as the antenna device 200 of the second embodiment, the same reference symbols are attached to those and description is omitted.

The antenna device 300 of the third embodiment includes antenna elements 310A and 310B and a ground element 20.

Further, an extending ground part 333 is provided between short stubs 311A and 311B of the antenna elements 310A and 310B. The short stub 311A, the extending ground part 333, and the short stub 311B are integrated. It can be deemed that the short stubs 311A and 311B are widened to integrate the extending ground part 333.

As described, even if the extending ground part 333 is provided, a linear part (a straight line) may be included or virtually exists, as illustrated by a broken line, between ends 311A1 and 311B1 for connecting the short stubs 311A and 311B to the ground element 20.

The lines 314A and 314B outward extend from the lines 14A and 14B of the antenna device 200 of the second embodiment along the Y axis. Further, the lines 317A and 317B extend in the negative direction along the Y axis from the end parts 316A and 316B. End parts of the lines 317A and 317B are opened ends 315A and 315B.

The antenna elements 310A and 310B includes the respective short stubs 311A and 311B, the respective power feeding lines 13A and 13B, the respective lines 314A and 314B, and the respective lines 317A and 317B.

Therefore, the lengths of the inverted-F antenna elements 310A and 310B, which are from the end 311A1 and 311B1 to the open ends 315A and 315B, may be set to be approximately one fourth of the wavelength λ of a frequency for use (λ/4).

In the antenna device 300, directions of polarization of the lines 314A and 314B are positive and negative directions of the Y axis, respectively, and directions of polarization of the lines 317A and 317B are positive and negative directions of the Y axis, respectively.

Therefore, the direction of polarization of the antenna element 310A is obtained by synthesizing the direction of polarization of the line 314A with the direction of polarization of the line 317A. The direction of polarization of the antenna element 310A can be expressed by a formula of Y=−X on the coordinate. Therefore, the direction of polarization of the antenna element 310E is obtained by synthesizing the direction of polarization of the line 314B with the direction of polarization of the line 317B. The direction of polarization of the antenna element 310B can be expressed by a formula of Y=−X on the coordinate.

The antenna device 300 of the third embodiment can be made smaller than the antenna device 200 (see FIG. 8) of the second embodiment since the lengths of the antenna elements 310A and 310B are set from the ends 311A1 and 311B1 to the open ends 315A and 315B to be approximately one fourth of the wavelength λ of the frequency for use (λ/4).

Because the lines 317A and 317B are electromagnetically connected to the ground element 20, by adjusting the lengths of the lines 317A and 317B and a distance from the ground element 20, frequency characteristics of the antenna device 300 can be adjusted.

Further, as described, the antenna device 300 of the third embodiment includes the ground element 20 shaped like the straight line between the ends 311A and 311B of the short stubs 311A and 311B and the extending ground part 333 protruding from the straight line.

Therefore, in a case where the antenna device 300 is mounted on one electronic device such as the USB dongle 1A and the Mini-PCI card 1B (see FIG. 1A and FIG. 1B) together with the RF communication device 3 and the MCU chip 4, spacial limitation is scarcely caused at the edge part 20A of the ground element 20. For example, since the RF communication device 3 can be arranged along the edge part 20A, the space can be saved.

In comparison with the above-described example antenna device in which the cut-off section is formed in the ground part, a parameter to be considered in order to obtain good antenna characteristics is reduced by the cut-off section. Therefore, a burden in designing the antenna device 300 is reduced.

As described, since the edge part 20A of the ground element 20 between the end 311A1 of the short stub 311A and the end 311B1 of the short stub 311B is shaped like the straight line in the antenna device 300 of the third embodiment and the extending ground part 333 extending from the straight line is provided, it is possible to provide the antenna device 300 which can be easily designed.

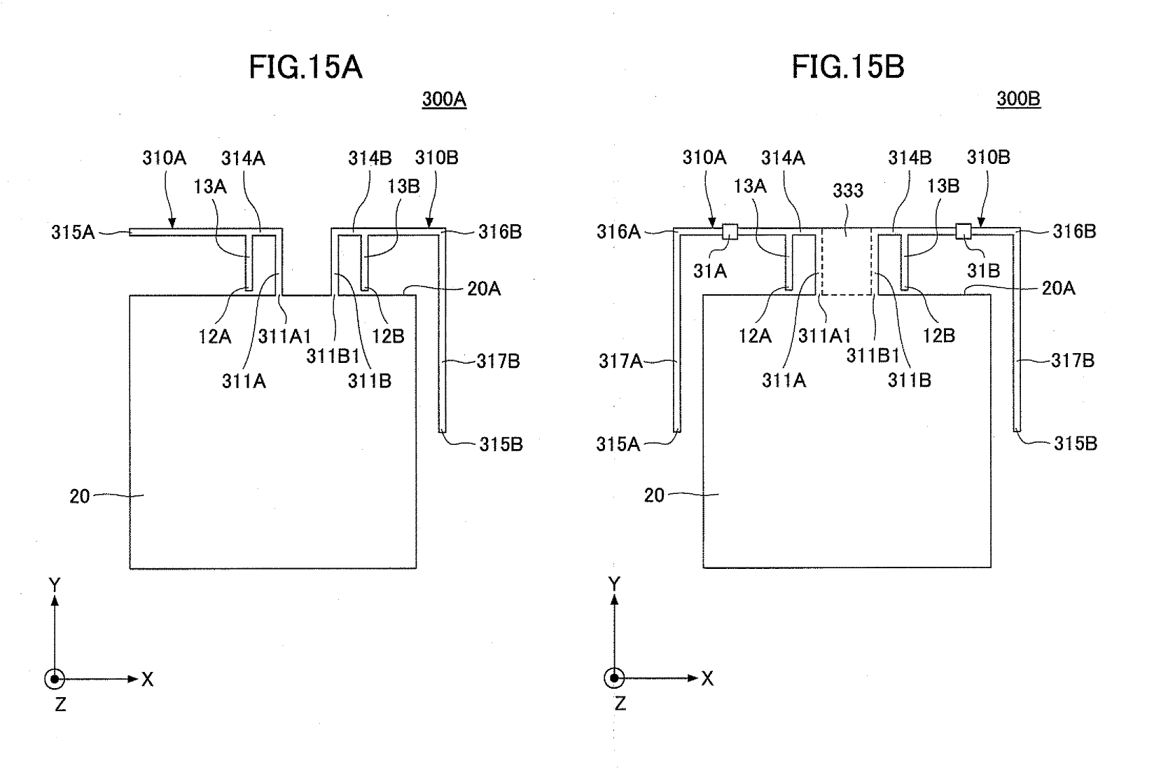

FIG. 15A and FIG. 15B illustrate antenna devices of a modified example of the third embodiment. FIG. 15A illustrates an antenna device 300A and FIG. 15B illustrates an antenna device 300B.

The antenna device 300A illustrated in FIG. 15A is obtained by removing the line 317A from the antenna device 300 illustrated in FIG. 14, making the length of a line 314B of the antenna device 300A shorter than the line 314B of the antenna device 300 (see FIG. 14), and making the length of a line 317B of the antenna device 300A longer than the line 317B of the antenna device 300 (see FIG. 14).

The total length of the short stub 311A and the line 314A is set to be approximately one fourth of the wavelength λ of the frequency for use (λ/4), and the total length of the short stub 311B of the antenna device 300A, the line 314B and the line 317B are set to be approximately one fourth of the wavelength λ of the frequency for use (λ/4).

An antenna device 300 illustrated FIG. 15B is obtained by inserting inductor chips 31A and 31B into lines 314A and 314B of the antenna device 300 illustrated in FIG. 14.

The size of the antenna device 300B can be miniaturized smaller than the antenna device 300 illustrated in FIG. 14.

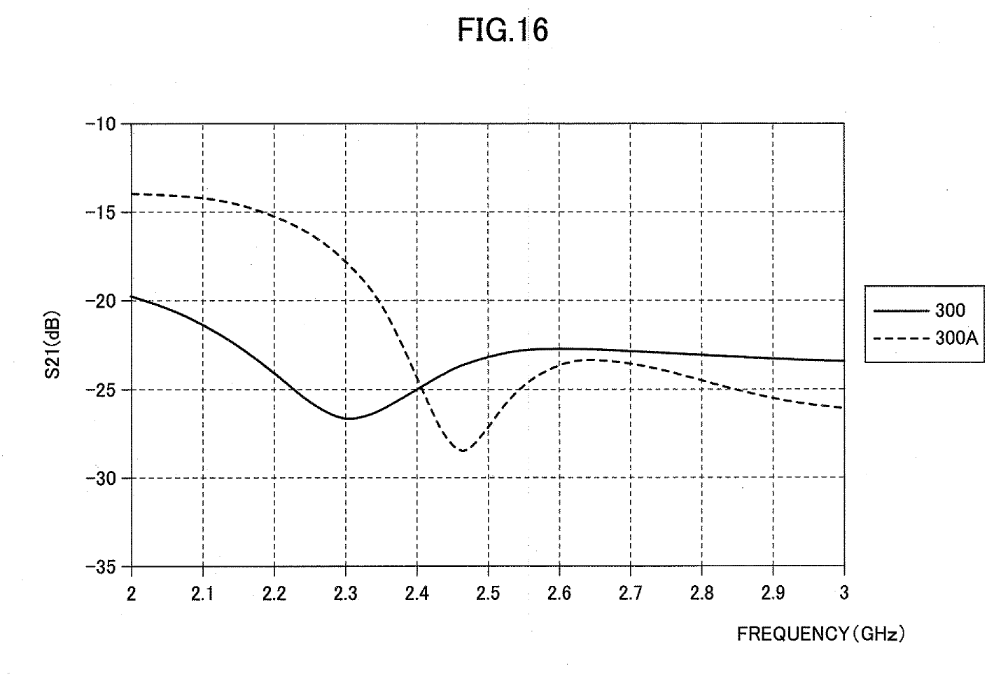

FIG. 16 illustrates S parameters (S21) of the antenna device 300 of the third embodiment and the antenna device 300A of the modified example of the third embodiment.

By comparing the S parameter (S21) of the antenna device 300 and the S parameter (S21) of the antenna device 300A, it is known that the frequencies corresponding to the local minimal values (or the minimum values) of S21 do not match.

Therefore, by adding the lines 317A and 317B to the antenna elements 310A and 3108 as described in the third embodiment, the frequency characteristics can be adjusted.

By adjusting the lengths of the lines 317A and 317B and the position of the lines 317A and 317B relative to the ground element 20, the value of the S parameter (S21) is made locally minimal or minimum.

### [d] Fourth Embodiment

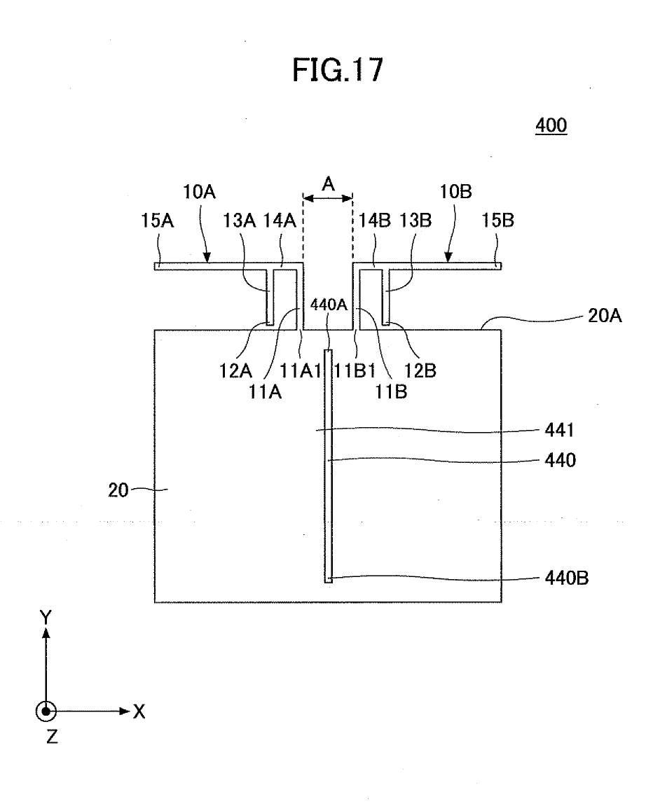

FIG. 17 is a plan view of an antenna device 400 of the fourth embodiment.

The antenna device 400 is obtained by adding a slot antenna 440 of the ground element 20 of the antenna device 100 (see FIG. 2). Because the other portions of the antenna device 400 of the fourth embodiment are the same as those of the first embodiment, the same reference symbols are attached to those and description is omitted.

The antenna device 400 includes antenna elements 10A and 10B, a ground element 20 and a slot antenna 440.

A slot antenna 440 is formed in a center of the ground element 20. The slot antenna 440 includes a slot formed along a Y axis in a center of an X direction of the ground element 20. The length in the X direction (i.e., a distance between a first end 440A and a second end 440B) slot antenna 44.0 is set to have a half of a wavelength for use λ. A power feeder 441 is provided at a position where λ/20 apart from the first end 440A.

The directions of polarization of the antenna elements 10A and 10B are positive and negative directions along the Y axis. The direction of polarization of the slot antenna 440 is positive and negative directions along the X axis.

The antenna device 400 can communicate by the slot antenna 440 in addition to the antenna elements 10A and 10B. For example, by using plural antenna devices 400, a multiple input multiple output (MIMO) communication can be realized between antenna devices 400 having three antennas.

Referring to an exploded perspective view of FIG. 18, a mode of mounting the antenna device 400 on the board 2 (see FIG. 1A and FIG. 1B) is described.

FIG. 18 is a perspective exploded view of the board 2 on which the antenna device of the fourth embodiment is mounted.

The antenna elements 10A and 10B are formed on the insulating layer 2A, and a RF communication device 3 is mounted on the insulating layer 2A. Power feeders 12A and 12B of the antenna element 10A and 10B are formed so as to receive electric power from the RF communication device 3 via microstriplines 3A and 3B.

A ground element 20 is formed on an insulating layer 2B. A slot antenna 440 is formed in a center of the ground element 20. The location of the ground element 20 on the insulating layer 2A is indicated by a broken line. Locations of the antenna elements 10A and 10B on the insulating layer 2B are indicated by broken lines.

The power feeder 441 of the slot antenna 440 is formed so as to receive electric power form the RF communication device 3 through a via (not illustrated) penetrating through the insulating layer 2A and the microstripline 3C formed on the insulating layer 2A.

The end 11A1 of a short stub 11A of the antenna element 10A is connected to a connecting part 21A of the ground element 20 by a via penetrating the insulating layer 2A in its thickness direction.

Similarly, the end 11B1 of a short stub 11B of the antenna element 10B is connected to a connecting part 21B of the ground element 20 by a via penetrating the insulating layer 2B in its thickness direction.

The RF communication device 3 is connected to the ground element 20 formed on the insulating layer 2B via an interlayer wiring (not illustrated).

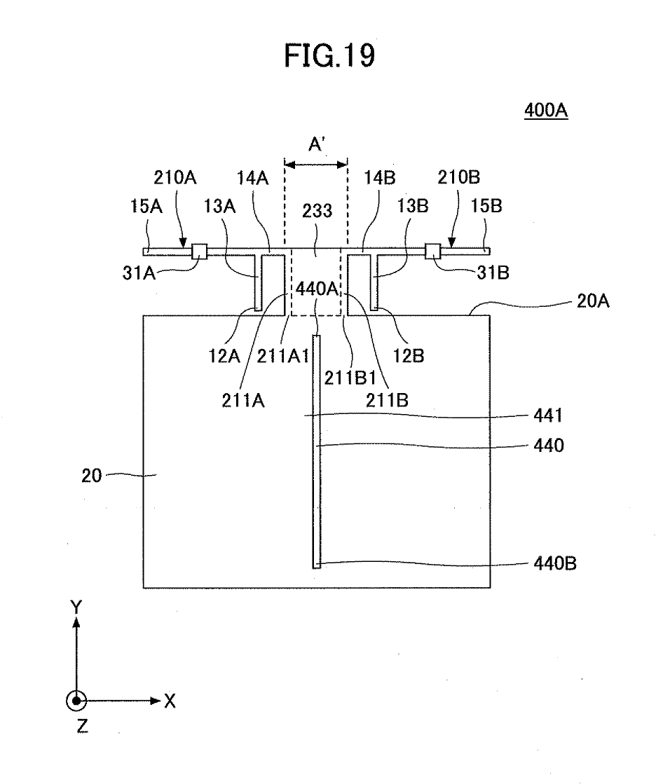

FIG. 19 is a plan view of an antenna device 400A of a modified example of the fourth embodiment.

The antenna device 400A is formed by adding a slot antenna 440 and inductor chips 31A and 31B to the antenna device 200 (see FIG. 8) of the Second Embodiment. The slot antenna 440 is similar to the slot antenna of the antenna device 400 illustrated in FIG. 17. The same reference symbols are attached to constructional elements same as the antenna device 200 of the second embodiment, and description of these portions is omitted.

The direction of polarization of antenna elements 210A and 210B is along a Y axis and the direction of polarization of the slot antenna 440 is along an X direction.

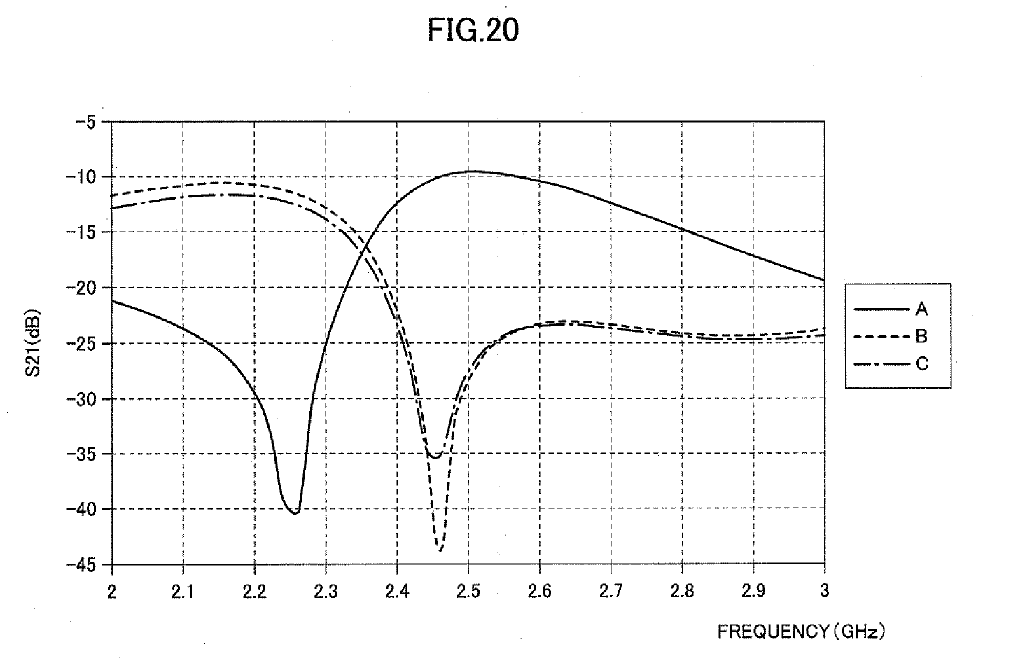

FIG. 20 is a graph for illustrating frequency characteristics of S parameters (S21) of the antenna elements and the slot antenna of the antenna device of the modified example of the fourth embodiment.

A characteristic A indicated by a solid line in FIG. 20 represents an insertion loss obtained at a time of communicating between the antenna element 210A and the antenna element 210B. Said differently, the characteristic A designates an insertion loss (S21 among the S parameters) obtained in the power feeder 12A or 12B in a case where the antenna element 210A communicates with the antenna element 210B.

A characteristic B indicated by a broken line in FIG. 20 represents an insertion loss (S21 among the S parameters) obtained at a time of communicating between the antenna element 210A and the slot antenna 440. Said differently, the characteristic B represents an insertion loss (S21 among the S parameters) obtained in the power feeder 12A or 441 in a case where the antenna element 210A communicates with the slot antenna element 210A.

A characteristic C indicated by a dot chain line in FIG. 20 represents an insertion loss (S21 among the S parameters) obtained at a time of communicating between the antenna element 210B and the slot antenna 440. Said differently, the characteristic C represents an insertion loss (S21 among the S parameters) obtained in the power feeder 12B or 441 in a case where the antenna element 210B communicates with the slot antenna 440.

In the characteristic A, a local minimal value of about −41 dB is obtained at about 2.25 GHz, and a local maximum value (or the maximum value) of about −10 dB is obtained at about 2.5 GHz.

In the characteristic B, a local minimal value (or the minimum value) of about −44 dB is obtained at about 2.45 GHz, and a local maximum value (or the maximum value) of about −11 dB is obtained at about 2.2 GHz.

In the characteristic C, a local minimal value (or the minimum value) of about −36 dB is obtained at about 2.45 GHz, and a local maximum value (or the maximum value) of about −12 dB is obtained at about 2.2 GHz.

From these results, it is known that a correlation between the antenna elements 210A and 210E and the slot antenna 440 is small.

As described, with the modified example of the fourth embodiment 4, it is possible to provide an antenna device 400A having a small correlation between the antenna elements 210A and 210B and the slot antenna 440.

For example, in a case where the number of the antenna devices 400A is plural, the MIMO communication such as WiMAX (“WiMAX” is the registered trademark) can be realized between the antenna devices 400A including the three antennas.

Further, in the antenna device 400 of the fourth embodiment, an edge part 20A (see FIG. 17) of the ground element 20 between the end 11A1 of the short stub 11A and the end 11B1 of the short stub 11B is shaped like a straight line.

Therefore, in a case where the antenna device 400 is mounted on one electronic device such as the USB dongle 1A and the Mini-PCI card 1B (see FIG. 1A and FIG. 1B) together with the RF communication device 3 and the MCU chip 4, spacial limitation is scarcely caused at the edge part 20A of the ground element 20. For example, since the RF communication device 3 can be arranged along the edge part 20A, the space can be saved.

In comparison with the above-described example antenna device in which the cut-off section is formed in the ground part, a parameter to be considered in order to obtain good antenna characteristics is reduced by the cut-off section. Therefore, a burden in designing the antenna device 400 is reduced.

As described, since the edge part 20A of the ground element 20 between the end 11A1 of the short stub 11A and the end 11B1 of the short stub 11B is shaped like a straight line, it is possible to provide the antenna device 400 which can be easily designed.

Further, the antenna device 400 of the fourth embodiment includes the slot antenna 440, and the correlation between the antenna elements 10A and 10B and the slot antenna 440 is low. Therefore, the MIMO communication such as the WiMAX (“WiMAX” is a registered trademark) can be realized between the antenna devices 400 including three antennas.

Further, as described, the antenna device 400A of the modified example of the fourth embodiment 200 includes the ground element 20 shaped like the straight line between the ends 211A and 211B of the short stubs 211A and 211B and an extending ground part 233 extending from the straight line.

Therefore, in a case where the antenna device 400 is mounted on one electronic device such as the USB dongle 1A and the Mini-PCI card 1B (see FIG. 1A and FIG. 1B) together with the RF communication device 3 and the MCU chip 4, spacial limitation is scarcely caused at the edge part 20A of the ground element 20. For example, since the RF communication device 3 can be arranged along the edge part 20A, the space can be saved.

In comparison with the above-described example antenna device in which the cut-off section is formed in the ground part, a parameter to be considered in order to obtain good antenna characteristics is reduced by the cut-off section. Therefore, a burden in designing the antenna device 400 is reduced.

As described, since the edge part 20A of the ground element 20 between the end 211A1 of the short stub 211A and the end 211B1 of the short stub 211B is shaped like the straight line in the antenna device 400A of the modified example of the second embodiment and the extending ground part 233 extending from the straight line is provided, it is possible to provide the antenna device 200 which can be easily designed.

Further, the antenna device 400A of the modified example of the fourth embodiment includes the slot antenna 440, and the correlation between the antenna elements 10A and 10B and the slot antenna 440 is low. Therefore, the MIMO communication such as the WiMAX (“WiMAX” is the registered trademark) can be realized between the antenna devices 400A including three antennas.

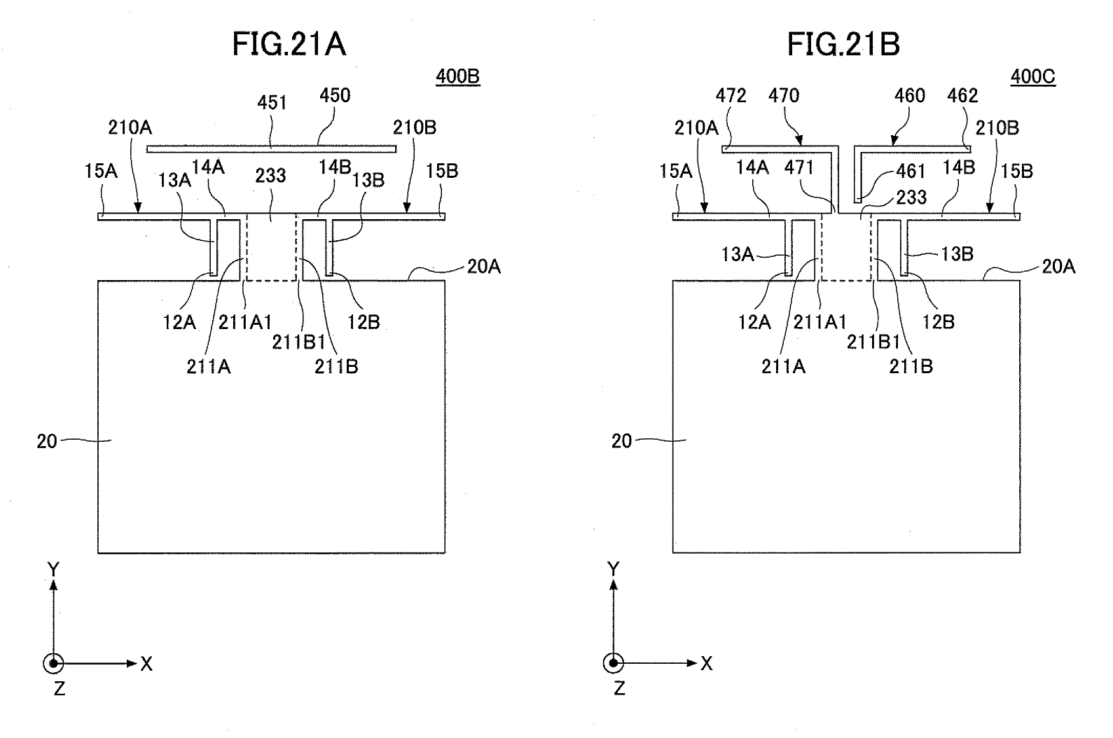

Referring to FIG. 21, antenna devices 400B and 400C of other modified examples of the fourth embodiment is described.

FIG. 21 illustrates the antenna devices 400B and 400C of the modified example of the fourth embodiment.

FIG. 21A illustrates an antenna device 400B of the modified example of the fourth embodiment, and FIG. 21B illustrates the antenna device 400C of the modified example of the fourth embodiment.

Referring to FIG. 21A, the antenna device 400B includes antenna elements 210A and 210B, a ground element 20, an extending ground part 233 and a dipole antenna 450.

The antenna device 400B illustrated in FIG. 21A is obtained by adding a dipole antenna 450 to the antenna device 200 (see FIG. 8) of the second embodiment. A power feeder 451 is provided in a center of the longitudinal direction of the dipole antenna 450. The dipole antenna 450 is the third antenna in addition to the first and second antennas of the antenna elements 210A and 210B.

Referring to FIG. 21B, the antenna device 400C includes antenna elements 210A and 210B, a ground element 20, an extending ground part 233, an antenna element 460 and a parasitic element 470.

The antenna device 4000 illustrated in FIG. 21B is obtained by adding an antenna element 460 and a parasitic element 470 to the antenna device 200 (see FIG. 8) of the second embodiment.

The antenna element 460 is shaped like L and includes a power feeder 461 in the vicinity of the extending ground part 233. The power feeder 461 includes an end of the antenna elements 460. The other end of the power feeder is an open end 462.

The parasitic element 470 is shaped like L. One end of the parasitic element 470 is connected to the extending ground part 233 and the other end of the parasitic element 470 is an open end 472.

When electric power is supplied to the power feeder 461 of the antenna element 460, the parasitic element 470 is excited along with the antenna element 460. Therefore, the antenna element 460 and the parasitic element 470 are used as the third antenna.

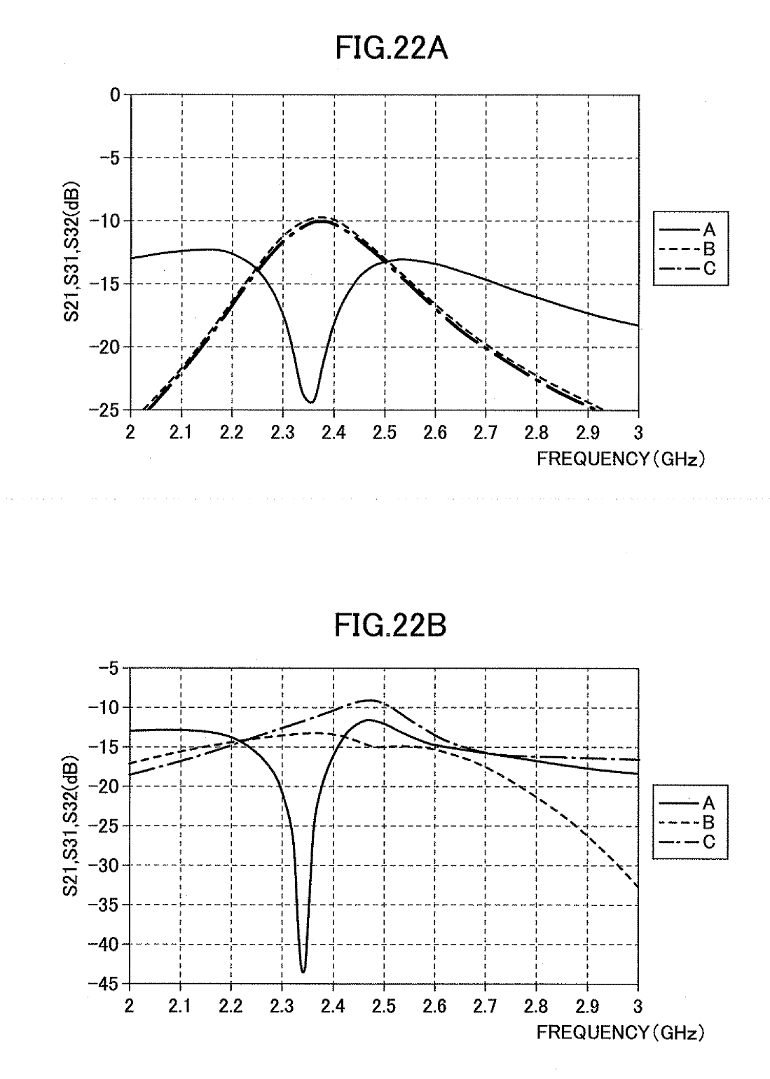

FIG. 22A and 22B are graphs illustrating frequency characteristics of S parameters (S21) of the antenna devices 400B and 400C of the modified examples of the fourth embodiment. FIG. 22A illustrates the frequency characteristics of S parameters (S21) between the antenna elements 210A and 210B and the dipole antenna 450 of the antenna devices 400B of the modified example of the fourth embodiment. FIG. 22B illustrates the frequency characteristics of S parameters (S21) between the antenna elements 210A and 210B and the dipole antenna 460 of the antenna devices 400C of the modified example of the fourth embodiment.

A characteristic A indicated by a solid line in FIG. 22A represents an insertion loss (S21 among the S parameters) obtained at a time of communicating between the antenna element 210A and the antenna element 210B. Said differently, the characteristic A designates the insertion loss (S21 among the S parameters) obtained in the power feeder 12A or 12B in a case where the antenna element 210A communicates with the antenna element 210B.

A characteristic B indicated by a broken line in FIG. 20A represents an insertion loss (S21 among the S parameters) obtained at a time of communicating between the antenna element 210A and the dipdle antenna 450. Said differently, the characteristic B represents the insertion loss (S21 among the S parameters) obtained in the power feeder 12A or 451 in a case where the antenna element 210A communicates with the dipole antenna 450.

A characteristic C indicated by a dot chain line in FIG. 20A represents an insertion loss (S21 among the S parameters) obtained at a time of communicating between the antenna element 210B and the dipole antenna 450. Because lines indicative of the characteristics B and C substantially overlap, these lines are slightly shifted each other for enabling seeing the lines. Said differently, the characteristic C represents the insertion loss (S21 among the S parameters) obtained in the power feeder 12B or 451 in a case where the antenna element 210B communicates with the dipole antenna 450.

In the characteristic A, a local minimal value (or the minimum value) of about −24 dB is obtained at about 2.35 GHz, and a local maximum value (or the maximum value) of about −15 dB is obtained at about 2.55 GHz.

The characteristics B and C are substantially the same, and the local maximal value (or the minimum value) is about −10 dB at around 2.4 GHz.

From these results, it is known that a correlation between the antenna elements 210A and 210B and the dipole antenna 450 is small.

As described, with the modified example of the fourth embodiment, it is possible to provide the antenna device 400A having a small correlation between the antenna elements 210A and 210B and the dipole antenna 450.

For example, in a case where the number of the antenna devices 400B is plural, the MIMO communication such as WiMAX (“WiMAX” is the registered trademark) can be realized between the antenna devices 400B including the three antennas.

A characteristic A indicated by a solid line in FIG. 22B represents an insertion loss (S21 among the S parameters) obtained at a time of communicating between the antenna element 210A and the antenna element 210B. Said differently, the characteristic A designates the insertion loss (S21 among the S parameters) obtained in the power feeder 12A or 12B in a case where the antenna element 210A communicates with the antenna element 210B.

A characteristic B indicated by a broken line in FIG. 20B represents an insertion loss (S21 among the S parameters) obtained at a time of communicating between the antenna element 210A and the slot antenna 460. Said differently, the characteristic B represents the insertion loss (S21 among the S parameters) obtained in the power feeder 12A or 461 in a case where the antenna element 210A communicates with the antenna element 460.

A characteristic C indicated by a dot chain line in FIG. 20B represents an insertion loss (S21 among the S parameters) obtained at a time of communicating between the antenna element 210B and the antenna element 460. Said differently, the characteristic C represents the insertion loss (S21 among the S parameters) obtained in the power feeder 12A or 461 in a case where the antenna element 210A communicates with the antenna element 460.

In the characteristic A, a local minimal value (or the minimum value) of about −43 dB is obtained at about 2.35 GHz, and the local maximum value (or the maximum value) of about −13 dB is obtained at about 2.45 GHz.

In the characteristics B, the local minimal value (or the minimum value) of about −15 dB is obtained at about 2.4 GHz, and the value decreases as the frequency increases.

In the characteristics C, the local minimal value (or the minimum value) of about −8 dB is obtained at about 2.45 GHz, and the value is around −15 dB through the entire wavelength.

From these results, it is known that the correlation between the antenna elements 210A and 210B and the antenna element 460 is small.

As described, with the modified example of the fourth embodiment, it is possible to provide the antenna device 400C having a small correlation between the antenna elements 210A and 210B and the dipole antenna 460.

For example, in a case where the number of the antenna devices 400C is plural, the MIMO communication such as WiMAX (“WiMAX” is the registered trademark) can be realized between the antenna devices 400C including the three antennas.

### [e] Fifth Embodiment

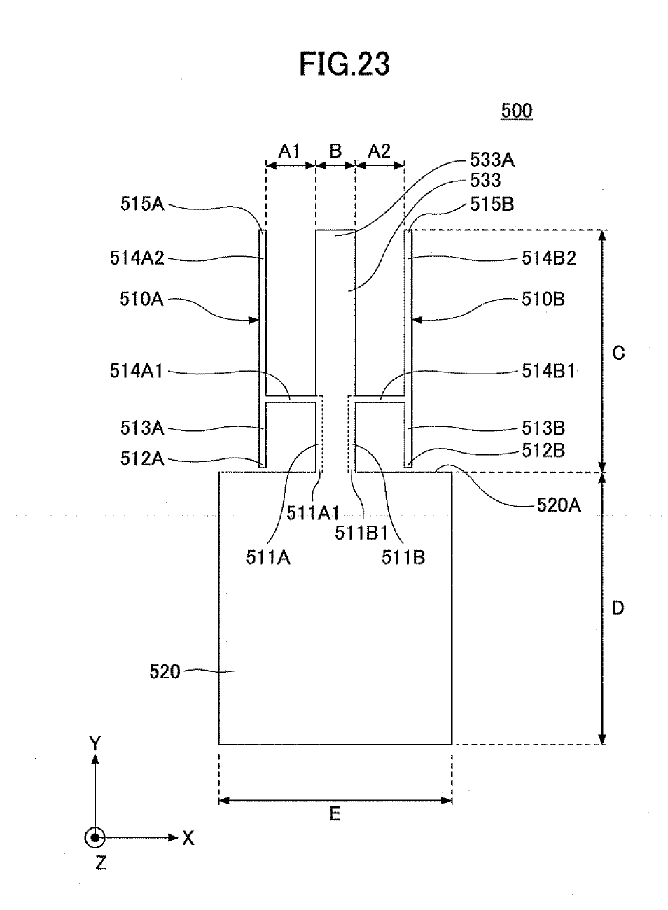

FIG. 23 is a plan view of an antenna device 500 of the fifth embodiment.

The antenna device 500 of the fifth embodiment has a structure different from that of the second embodiment (see FIG. 8). The antenna device 200 is modified by bending the open ends 15A and 15B of the lines 14A and 14B in the positive direction of the Y axis from the power feeding lines 13A and 13B, and the extending ground part 233 is extended in the positive direction of the Y axis to obtain the antenna device 500.

The antenna device 500 includes antenna elements 510A and 510B, a ground element 520 and an extending ground part 533.

The antenna element 510A includes a short stub 511A, a power feeding line 513A, and lines 514A1 and 514A2.

The antenna element 510B includes a short stub 511B, a power feeding line 513B, and lines 514B1 and 514B2.

The extending ground part 533 extends or protrudes from the edge part 520A of the ground part 520 in the positive direction along the Y axis between the antenna elements 510A and 510B.

The short stub 511A of the antenna element 510A is included in the extending ground part 533. The short stub 511B of the antenna element 510B is also included in the extending ground part 533.

One end 511A1 of the short stub 511A is connected to the ground element 520, and one end 511B1 of the short stub 511B is connected to the ground element 520. A portion between the ends 511A1 and 511B1 is shaped like a straight line. The extending ground part 533 extends or protrudes from the portion in the positive direction along the Y axis.

The line 514A1 diverges from the extending ground part 533 and extends or protrudes in the negative direction along the X axis. At the end part of the line 514A1, the power feeding line 513A and the line 514A2 are connected.

The power feeding line 513A extends or protrudes in the negative direction along the Y axis and includes a power feeder 512A at the end in the vicinity of the ground element 520.

The line 514A2 extends or protrudes in the positive direction along the Y axis. The end part of the line 514A2 is an open end 515A.

The line 514B1 diverges from the extending ground part 533 and extends or protrudes in the positive direction along the X axis. At the end part of the line 514B1, the power feeding line 513B and the line 514B2 are connected.

The power feeding line 513B extends or protrudes in the negative direction along the Y axis and includes a power feeder 512B at the end in the vicinity of the ground element 520.

The line 514B2 extends or protrudes in the positive direction along the Y axis. The end part of the line 514B2 is an open end 515B.

The end part 533A of the extending ground part 533 and the open ends 515A and 515B are arranged at the same position along the Y axis.

As described, the antenna device 500 of the fifth embodiment has a structure different from that of the second embodiment (see FIG. 8) so that the antenna device 200 is modified by bending the open ends 15A and 158 of the lines 14A and 14B in the positive direction of the Y axis from the power feeding lines 13A and 13B, and the extending ground part 233 is extended in the positive direction of the Y axis to obtain the antenna device 500. Therefore, the antenna elements 510A and 510B are an inverted-F type.

Here, A1 designates the dimension between the line 514A2 and the extending ground part 533, B designates a width of the extending part 533, A2 designates the dimension between the extending ground part 533 and the line 514B2, C designates the length between the edge part 520A of the ground element 520 and the end part 533A of the extending ground part 533, D designates the length of the ground element 520 in the longitudinal direction, and E designates the width of the ground element 520.

For example, the dimensions A1 and A2 are 3 mm, the width B is 2 mm, the length C is 21 mm, the length D is 25 mm, and the length E is 15 mm. These are exemplary values in a case where the frequency of use of the antenna device 500 is 2.45 GHz.

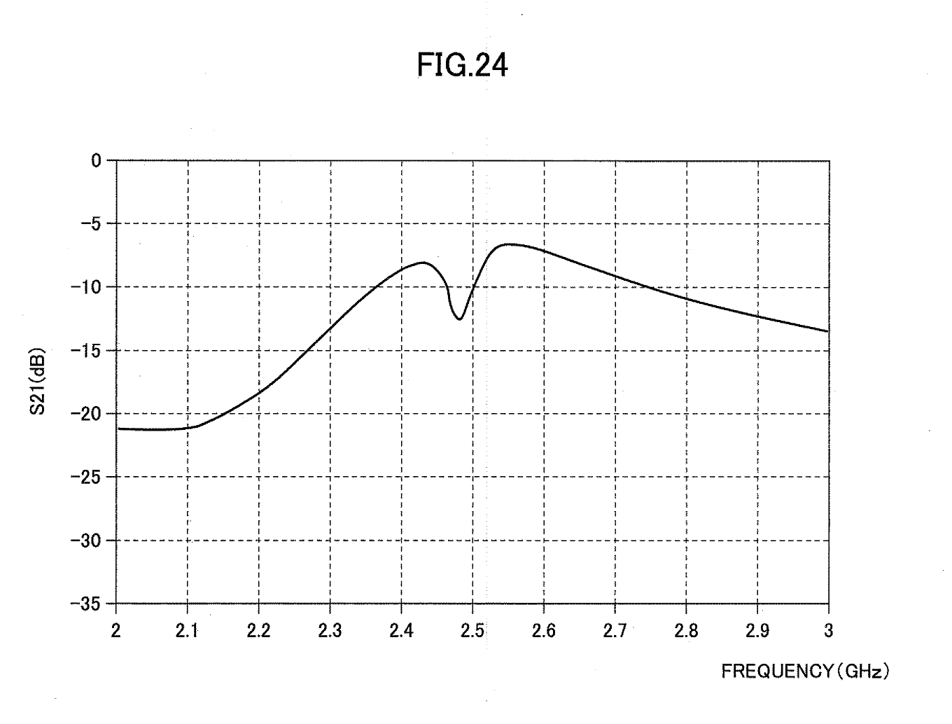

Referring to FIG. 24, the frequency characteristics (S21 among S parameters) of the antenna device 500 of the fifth embodiment is described next.

FIG. 24 is a graph illustrating the frequency characteristics (S21 among S parameters) of the antenna device 500 of the fifth embodiment.

The S parameter illustrated in FIG. 24 represents an insertion loss (S21 of the S parameters) obtained at a time of communicating between the antenna element 510A and the antenna element 510B. Said differently, FIG. 24 illustrates the insertion loss (S21 among the S parameters) obtained in the power feeder 512A or 512B in a case where the antenna element 510A communicates with the antenna element 510B.

Referring to FIG. 24, the local minimal value (or the minimum value) of about −12 dB is obtained at around 2.45 GHz. For comparison, an S parameter (S21) is obtained for a comparative antenna device which does not include lines 514A1 and 514B1. In this comparative antenna device, no local minimal value is obtainable. The local minimal value (or the minimum value) of the antenna device 500 of the fifth embodiment 500 is lower by about −7 dB than that of the comparative antenna device.

As described, with the fifth embodiment, it is possible to provide the antenna device 500 in which interference between the two inverted-F antenna elements 510A and 510E is reduced.

The antenna device 500 can be used for communication for wireless LAN or a diversity antenna. By using a plurality of such antenna devices 500, the MIMO communication such as WiMAX (“WiMAX” is the registered trademark) can be realized.

Further, as described, the antenna device 500 of the fifth embodiment includes the ground element 520 shaped like the straight line between the ends 511A and 511B of the short stubs 511A and 511B and the extending ground part 533 extending (protruding) from the straight line in the positive direction of the Y axis.

Therefore, in a case where the antenna device 500 is mounted on one electronic device such as the USB dongle 1A and the Mini-PCI card 1B (see FIG. 1A and FIG. 1B) together with the RF communication device 3 and the MCU chip 4, spacial limitation is scarcely caused at the edge part 520A of the ground element 520. For example, since the RF communication device 3 can be arranged along the edge part 520A, the space can be saved.

In comparison with the above-described example antenna device in which the cut-off section is formed in the ground part, a parameter to be considered in order to obtain good antenna characteristics is reduced by the cut-off section. Therefore, a burden in designing the antenna device 500 is reduced.

With the fifth embodiment, since the edge part 520A of the ground element 20 between the end 511A1 of the short stub 511A and the end 511B1 of the short stub 511B is linear or shaped like the straight line, it is possible to provide the antenna device 500 which can be easily designed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority or inferiority of the invention. Although the embodiments of the present invention have been described in detail, it should be understood that the various changes, substitutions, and alterations could be made hereto without departing from the spirit and scope of the invention.

What is claimed is:

1. An antenna device comprising:
a ground part;
a first stub connected to the ground part;
a first inverted-F antenna element including a first power feeder;
a second stub connected to the ground part; and
a second inverted-F antenna element including a second power feeder,
wherein the ground part has a linear part between a first connecting part between the first stub part and the ground part and a second connecting part between the second stub part and the ground part.

2. The antenna device according to claim 1,
wherein the ground part includes an extending ground part extending from the linear part in a direction along the first stub and the second stub.

3. The antenna device according to claim 1, further comprising:
a first parasitic element connected to the ground part and arranged in a vicinity of the first antenna element; and
a second parasitic element connected to the ground part and arranged in a vicinity of the second antenna element.

4. The antenna device according to claim 1, further comprising:
a first inductor inserted between the first power feeder and an end of the first inverted-F antenna element; and
a second inductor inserted between the second power feeder and an end of the second inverted-F antenna element.

5. The antenna device according to claim 1, further comprising:
a first branching line provided between the first power feeder and an end of the first inverted-F antenna element; and
a second branching line provided between the second power feeder and an end of the second inverted-F antenna element.

6. The antenna device according to claim 1,
wherein a distance between the first connecting part and the second connecting part is one twentieth of a frequency for use or smaller.

7. The antenna device according to claim 1, further comprising:
a first extending line slantwise provided on an end of the first inverted-F antenna element; and
a second extending line slantwise provided on an end of the second inverted-F antenna element.

8. The antenna device according to claim 1, further comprising:
a slot power feeder,
wherein the ground part includes a slot to which electric power is fed from the slot power feeder.

9. The antenna device according to claim 1, further comprising:
a third antenna element having a direction of polarization different from directions of polarization of the first and second antenna elements,
wherein the directions of polarization of the first and second antenna elements are same.

10. The antenna device according to claim 9,
wherein the third antenna element includes a third power feeder which is provided apart from the first antenna element, the second antenna element and the ground part.

11. The antenna device according to claim 2,
wherein the third antenna element includes
an antenna part including a third power feeder connected to the ground part, and
a third parasitic element connected to the ground part.

12. An antenna device comprising:
a ground part including an extending ground part;
a first inverted-F antenna element including
a first stub connected to the extending ground part, and
a first power feeder; and
a second inverted-F antenna element including
a second stub connected to the extended ground part, and
a second power feeder,
wherein the first inverted-F antenna element and the second inverted-F antenna element are arranged opposite to each other with respect to the extending ground part.

13. An electronic device comprising:
the antenna device according to claim 1; and
a communication device connected to the antenna device, the communication device configured to perform wireless communication.
